(19) United States
(12) Patent Application Publication
(10) Pub. No.: US 2026/0238323 A1
(43) Pub. Date: Aug. 13, 2026

(54) SINGLE DEFAULT TCI FOR DOWNLINK IN UNIFIED TCI BASED MULTI-TRP OPERATION

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/155,542

(22) PCT Filed: Apr. 5, 2023
(86) PCT No.: PCT/CN2023/086347

§ 371 Date: Aug. 11, 2025

(51) Int. Cl. H04B 7/06; H04W 72/1273; H04W 72/231; H04W 76/20

(52) U.S. Cl. CPC H04B 7/06968; H04W 72/1273; H04W 72/231; H04W 76/20

(57) ABSTRACT

The apparatus, in some aspects, may be configured to receive one or more indications associated with multiple unified TC states for a multi-TRP mode of operation of the wireless device. The apparatus may further be configured to receive, from at least one TRP of multiple TRPs, control information scheduling a downlink transmission from the multiple TRPs within a threshold amount of time following the control information and receive the downlink transmission using a unified TCI state of the multiple unified TCI states based on the downlink transmission being within the threshold amount of time following the control information.

### TECHNICAL FIELD

The present disclosure relates generally to communication systems, and more particularly, to wireless communication associated with a wireless device that supports communication with multiple transmission reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP™) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus, in some aspects, may be a wireless device and may be configured to receive one or more indications associated with multiple unified transmission configuration indication (TCI) states for a multi-TRP mode of operation of the wireless device. The apparatus may further be configured to receive, from at least one TRP of multiple TRPs, control information scheduling a downlink transmission from the multiple TRPs within a threshold amount of time following the control information and receive the downlink transmission using a unified TCI state of the multiple unified TCI states based on the downlink transmission being within the threshold amount of time following the control information.

In an aspect of the disclosure, a method, a computer-readable medium, and an apparatus are provided. The apparatus, in some aspects, may be a network device (e.g., a base station or other network device associated with at least one TRP) and may be configured to indicate, for a particular wireless device, one or more unified TCI states of multiple unified TCI states for a multi-TRP mode of operation of the particular wireless device. The apparatus may further be configured to provide, to the particular wireless device, control information scheduling a downlink transmission from at least one of the multiple TRPs within a threshold amount of time following the control information and provide the downlink transmission using a unified TCI state of the multiple unified TCI states based on the downlink transmission being within the threshold amount of time following the control information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a unified TCI framework in accordance with some aspects of the disclosure.

FIG. 5 is a diagram, illustrating the selection of unified TCI states for inclusion in, or associate with, a set of TCI codepoints in accordance with some aspects of the disclosure.

FIG. 6 includes a diagram illustrating an example in which a first TRP sends, to a UE, an sDCI with scheduling information for downlink communication, such as PDSCH or AP CSI-RS, from the first TRP and the second TRP.

FIG. 7 is a diagram illustrating that for mTRP PDSCH, one or more of spatial division multiplexing (SDM), frequency division multiplexing (FDM), or time division multiplexing (TDM) may be employed for the PDSCHs from different TRPs in accordance with some aspects of the disclosure.

FIG. 8 is a call flow diagram illustrating a method for identifying, selecting, and/or determining a default TCI state for receiving at least one DL transmission for each of multiple TRPs within a time period after receiving control information scheduling the at least one DL transmission for each of multiple TRPs in accordance with some aspects of the disclosure.

FIG. 9 is a call flow diagram illustrating a method for identifying, selecting, and/or determining a default TCI state for receiving at least one DL transmission for each of multiple TRPs within a time period after receiving control information scheduling the at least one DL transmission for each of multiple TRPs in accordance with some aspects of the disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

In some aspects of wireless communication, a unified TCI framework may be configured for indication of DL and/or UL TCI states for multiple channels. The unified TCI framework, in some aspect, may be associated with a multi-TRP use case. In some aspects, the unified TCI framework may be associated with a joint DL and UL unified (or common) TCI state pool, where each unified TCI state may be used to indicate a common TCI state (e.g., a beam) for a plurality of DL channels (or reference signals (RS)) or to indicate a common TCI state for a plurality of UL channels (or RSs). In some aspects, a DL unified TCI state pool may be used to indicate a common TCI state (or beam) for more than one DL channel (or RS), while a separate UL unified TCI state pool may be used to indicate a common TCI state (or beam) for more than one UL channel (or RS). Unified TCI states for inclusion in, or association with, a set of TCI codepoints may be selected, indicated, or identified from the unified TCI state pool. The set of TCI codepoints, in some aspects, may be an indexed list of a subset of unified TCI states from the unified TCI state pool that may be selected and/or indicated for selection by an indication in a grant (e.g., an n-bit TCI indication in a DCI, where n is number of bits that can unambiguously identify an index to the set, or list, of TCI codepoints and that is smaller than a second number of bits, m, that could be used to unambiguously identify a particular unified TCI state from the unified TCI state pool).

One or more codepoints for mTRP applications may be associated with multiple TCI states, e.g., one unified TCI state identified by each TRP of the multiple TRPs connected to a wireless device. A unified TCI framework for mTRP applications may, in some aspects, be associated with a grant for resources associated with multiple TRPs, the grant (e.g., a single downlink control information (DCI) (sDCI)) may be received from a single TRP of multiple TRPs, or multiple grants (e.g., multiple DCI (mDCI)) may be received from multiple TRPs. In some aspects, a grant (e.g., an sDCI) received from a single TRP of multiple TRPs may include a 2-bit TCI-selection field to identify at least one TCI state (e.g., one unified TCI state from a set of two unified TCI states associated with an indicated TCI codepoint) associated with the multiple TRPs. The 2-bit TCI-selection field, in some aspects, may be configured by RRC to be present in the grant (e.g., an sDCI format based on DCI format 1_1 or DCI format 1_2) scheduling (or activating) physical DL shared channel (PDSCH) reception (including dynamic PDSCH and semi-persistently scheduled (SPS) PDSCH) or an aperiodic (AP) channel state information (CSI) RS (AP CSI-RS). In some aspects, the 2-bit TCI-selection field of the grant (e.g., the sDCI) being equal to “00” may indicate for a wireless device to apply the first of two indicated joint, or DL, TCI states to each PDSCH DMRS port(s) of corresponding PDSCH transmission (or AP CSI-RS) occasions(s) scheduled (or activated) by the grant (e.g., the sDCI using DCI format 1_1 or DCI format 1_2). Similarly, the 2-bit TCI-selection field of the grant (e.g., an sDCI) being equal to “01” may indicate for a wireless device to apply the second of two indicated joint, or DL, TCI states to each PDSCH DMRS port(s) of corresponding PDSCH transmission (or AP CSI-RS) occasions(s) scheduled (or activated) by the grant (e.g., the sDCI using DCI format 1_1 or DCI format 1_2). Additionally, in some aspects, the 2-bit TCI-selection field of the grant (e.g., an sDCI) being equal to “10” may indicate for a wireless device to apply both indicated joint, or DL, TCI states to the PDSCH reception (e.g., the DMRS port(s) of corresponding PDSCH transmission (or AP CSI-RS) occasions(s)) scheduled (or activated) by the grant (e.g., the sDCI using DCI format 1_1 or DCI format 1_2). While specific values that may be used for the 2-bit TCI-selection field are discussed above, some aspects may use different values (e.g., a different mapping of values) to indicate which TCI state(s) to apply for a PDSCH occasion scheduled by a grant including the 2-bit TCI-selection field and may indicate at least one additional behavior.

The selection of the unified TCI state from a set of two unified TCI states indicated in a TCI codepoint (e.g., by reference to a unified TCI state pool for DL (either a joint DL/UL, or separate DL, unified TCI state pool) described above) may apply to the scheduled (or activated) PDSCH reception when the offset between the reception of the scheduling grant (e.g., the sDCI using, for example, DCI format 1_1 or DCI format 1_2) and the scheduled (or activated) PDSCH reception is equal to or larger than a threshold (e.g., a threshold similar to timeDurationForQCL that may be configured for the mTRP application or associated with an sDCI).

Various aspects of the disclosure relate generally to selecting a default beam for reception of DL transmissions within a threshold amount of time (e.g., a threshold similar to timeDurationForQCL that may be configured for the mTRP application or associated with an sDCI) following a reception of control information scheduling the DL transmissions (e.g., a grant such as an sDCI or mDCI). Some aspects more specifically relate to selecting (or using), at a wireless device supporting a single default TCI state (or beam), a default TCI state (or beam) for receiving DL transmissions (e.g., PDSCH or CSI-RS) associated with mTRP DL transmissions within the threshold amount of time following the control information. Accordingly, aspects of the disclosure may allow a base station (e.g., a base station including one or more of the multiple TRPs) and a connected wireless device to select a same TCI state (or beam) for a DL transmission scheduled within a threshold time of (transmission and/or reception of) a grant scheduling the DL transmission. The DL transmission, in some aspects, may be a PDSCH or an AP CSI-RS. In some aspects, a wireless device may receive one or more indications (e.g., via control information) associated with multiple unified TCI states for an mTRP mode of operation of the wireless device. The wireless device may receive, from at least one TRP of multiple TRPs, control information (e.g., a DCI such as sDCI or mDCI) scheduling a downlink transmission from the multiple TRPs within a threshold amount of time following the control information. In some aspects, the control information may include a TCI selection indication. Based on receiving the control information, the wireless device may receive the DL transmission using a unified TCI state of the multiple TCI states based on the DL transmission being within the threshold amount of time following the control information. The unified TCJ state used to receive the DL transmission may be selected as will be described below.

In some aspects, a corresponding network device (e.g., a base station) associated with at least one TRP of the multiple TRPs may indicate, for a particular wireless device, one or more unified TCJ states of the multiple unified TCJ states for the mTRP mode of operation of the particular wireless device. The network device may additionally, or alternatively, provide, to the particular wireless device, control information (e.g., an sDCI or one of a set of mDCI) scheduling a downlink transmission from at least one of the multiple TRPs within a threshold amount of time following the control information. In some aspects, the control information (e.g., an sDCI) may include the indication of the unified TCJ state of the multiple unified TCJ states. The network device may provide the downlink transmission using the unified TCJ state of the multiple unified TCJ states based on the downlink transmission being within the threshold amount of time following the control information. The unified TCJ state used for receiving (or transmitting) the downlink transmission may be selected in one of multiple manners as will be described below.

Particular aspects of the subject matter described in this disclosure can be implemented to realize one or more of the following potential advantages. In some examples, by configuring a default-unified-TCI-state selection and/or determination, the described techniques can be used to improve the reception of DL transmission(s) scheduled within a threshold time after control information (e.g., sDCI or mDCI) scheduling the DL transmission(s) by ensuring that the TRP(s) transmitting the DL transmission(s) uses a same TCJ state as the wireless device receiving the DL transmission(s).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

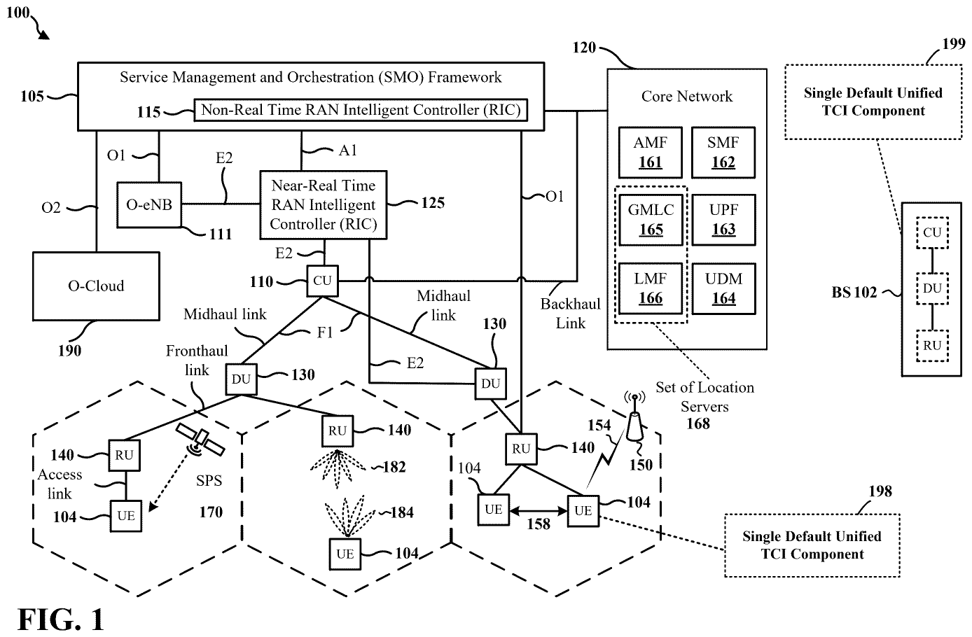

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP™. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™, Wi-Fi™ based on the Institute of Electrical and Electronics Engineers (IEEE) 802.11 standard, LTE, or NR.

The wireless communications system may further include a Wi-Fi™ AP 150 in communication with UEs 104 (also referred to as Wi-Fi™ stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth™ signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a single default unified TCI component 198 that may be configured to receive one or more indications associated with multiple unified TCI states for a multi-TRP mode of operation of the wireless device. The single default unified TCI component 198 may further be configured to receive, from at least one TRP of multiple TRPs, control information scheduling a downlink transmission from the multiple TRPs within a threshold amount of time following the control information and receive the downlink transmission using a unified TCI state of the multiple unified TCI states based on the downlink transmission being within the threshold amount of time following the control information. In certain aspects, the base station 102 may have a single default unified TCI component 199 that may be configured to indicate, for a particular wireless device, one or more unified TCI states of multiple unified TCI states for a multi-TRP mode of operation of the particular wireless device. The single default unified TCI component 199 may further be configured to provide, to the particular wireless device, control information scheduling a downlink transmission from at least one of the multiple TRPs within a threshold amount of time following the control information and provide the downlink transmission using a unified TCI state of the multiple unified TCI states based on the downlink transmission being within the threshold amount of time following the control information. While aspects of the discussion below may focus on aspects relating to a mTRP environment including two TRPs and using a unified TCI state, the concepts may be applied to more complex mTRP environments using other methods of identifying TCI states associated with DL channels.

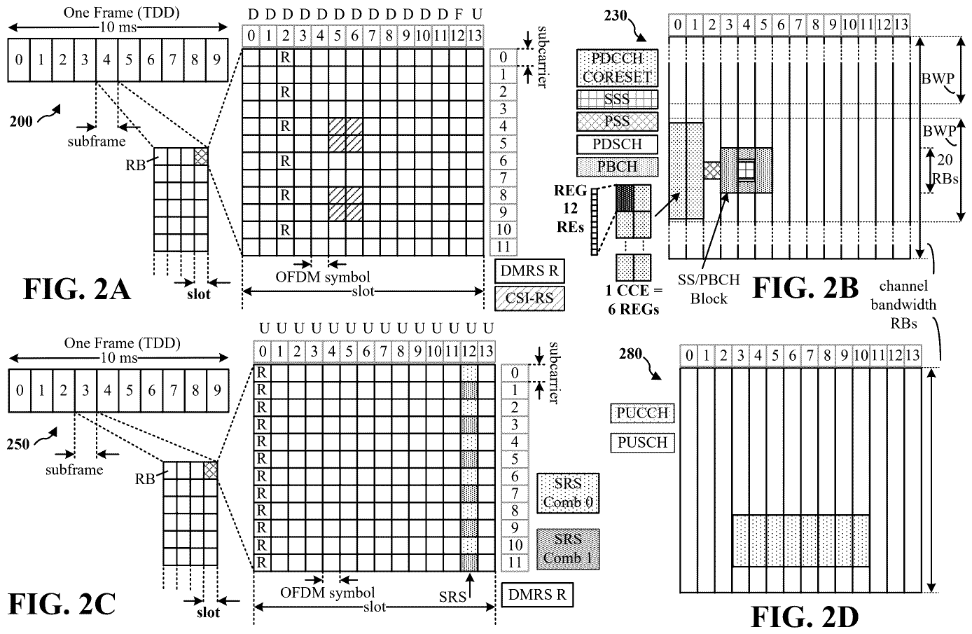

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ}·15 [KHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ}slots/subframe. The subcarrier spacing may be equal to 2*15 kHz, where μ is the numerology 0 to 4. As such, the numerology p=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology p=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

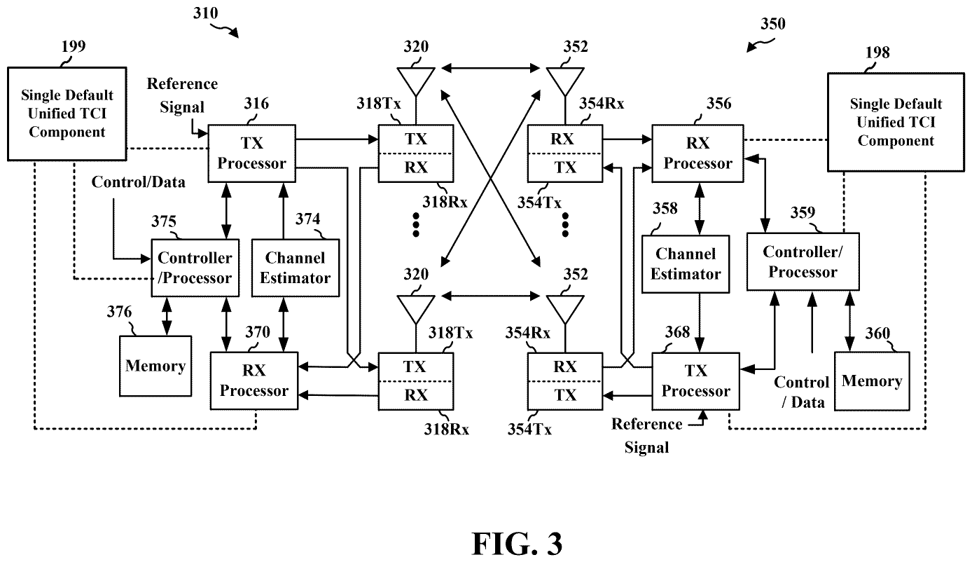

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the single default unified TCI component 198 of FIG. 1.

At least one of the TX processor 316, the RX processor 370, and the controller/processor 375 may be configured to perform aspects in connection with the single default unified TCI component 199 of FIG. 1.

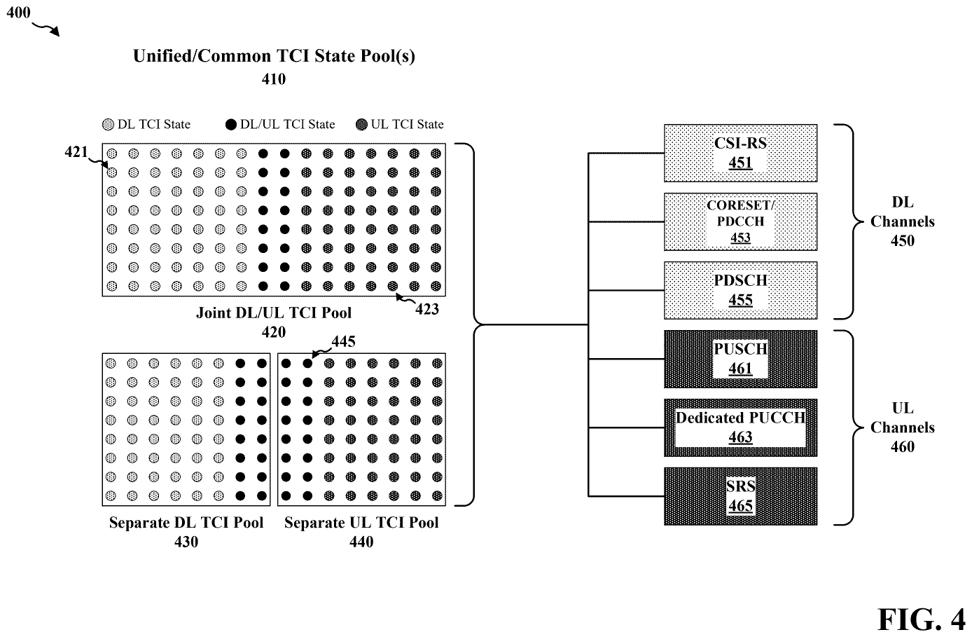

In some aspects of wireless communication, a unified TCI framework may be configured for indication of DL and/or UL TCI states for multiple channels. FIG. 4 is a diagram 400 illustrating a unified TCI framework in accordance with some aspects of the disclosure. The unified TCI framework, in some aspect, may be associated with a multi-TRP use case. In some aspects, the unified TCI framework may be associated with unified (or common) TCI state pool(s) 410. The unified (or common) TCI state pool(s) 410, in some aspects, may include one or more of a joint DL/UL unified (or common) TCI state pool 420 or a separate DL unified TCI state pool 430 and a separate UL unified TCI state pool 440. Each unified TCI state, in some aspects, may be used to indicate a common TCI state (e.g., a beam or other QCL properties) for a plurality of DL channels 450 (where the DL channels may refer more broadly to DL transmissions including RS) or to indicate a common TCI state for a plurality of UL channels 460 (where the UL channels may refer more broadly to UL transmissions including RS). For example, a unified (DL) TCI state may be associated with, or used to receive, CSI-RS 451, CORESET/PDCCH 453, and PDSCH 455 and a unified (UL) TCI state to transmit PUSCH 461, dedicated PUCCH 463, or SRS 465. As indicated in diagram 400, a particular unified TCI state may be a candidate TCI state for application to any of DL channels (e.g., unified TCI state 421), UL channels (e.g., unified TCI state 423), or both DL and UL channels (e.g., unified TCI state 445).

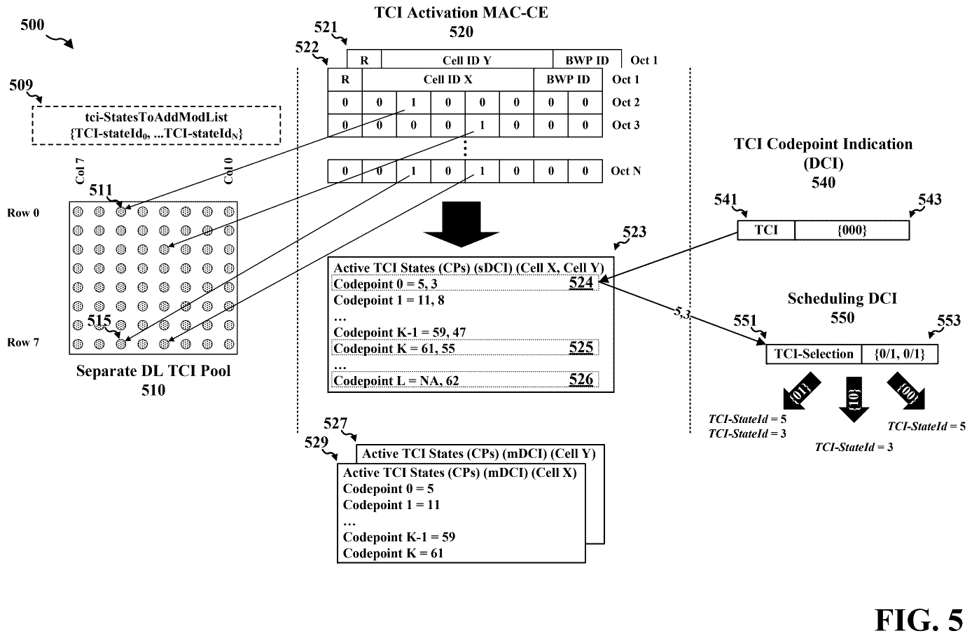

FIG. 5 is a diagram 500, illustrating the selection of unified TCI states for inclusion in, or associate with, a set of TCI codepoints in accordance with some aspects of the disclosure. For example, a separate DL unified TCI state pool 510 may be configured by RRC signaling (e.g., a tci-StatesToAddModList 509) to include a set of M (e.g., 64 or 128) TCI state identifiers (e.g., TCI-StateId). The identified TCI states (e.g., unified TCI states) are illustrated as being organized in columns and rows to indicate a correspondence to a bitmap organized in octets (e.g., the bitmap included in octets 2-N of a TCI activation indication 521 or a TCI activation indication 522) but may be structured differently (e.g., as an ordered list) in some aspects.

A network device (or base station) associated with a TRP may transmit one of a set of TCI activation messages 520 (e.g., via a MAC-CE), e.g., the TCI activation indication 521 or the TCI activation indication 522. The TCI activation indication 521 or 522 may include a set of up to L bits (where L is a maximum size of a TCI codepoint list, e.g., 8 or 16) with a value set to “1” to indicate an activation of a corresponding unified TCI state in the separate DL unified TCI state pool 510 with the rest having a value set to “0” to indicate inactivation or non-activation of the corresponding unified TCI state in the separate DL unified TCI state pool 510. For example, TCI activation indication 522 is illustrated as indicating an activation of a set of unified TCI states (e.g., including unified TCI state 511 and unified TCI state 515 with indexes 5 and 61, respectively). The TCI activation indication 521 and the TCI activation indication 522 may each include a cell ID for an associated TRP in a multi-TRP environment.

As illustrated, the combined set of TCI codepoints 523 or the set of TCI codepoints 527 and the set of TCI codepoints 529, in some aspects, may be an indexed list of a subset of unified TCI states from the unified TCI state pool that may be selected and/or indicated for selection by an indication in a grant (e.g., an n-bit TCI indication in a DCI, where n is number of bits that can unambiguously identify an index to the set, or list, of TCI codepoints and that is smaller than a second number of bits, m, that could be used to unambiguously identify a particular unified TCI state from the unified TCI state pool). As indicated in the combined set of TCI codepoints 523, a first TRP (or cell) may activate a different number of unified TCI sates for association with a TCI codepoint index.

One or more codepoints for mTRP applications may be associated with multiple TCI states, e.g., one unified TCI state identified by each TRP of the multiple TRPs connected to a wireless device (e.g., TCI codepoint 524 and TCI codepoint 525 may be associated with two unified TCI states), while other TCI codepoints may be associated with a single unified TCI state (e.g., TCI codepoint 526). One or more TRPs may provide a TCI codepoint indication 540 (e.g., via DCI) indicating a particular (active) codepoint and/or unified TCI (e.g., via the value 543 for a TCI field 541 indicating TCI codepoint 0 associated with unified TCIs 5 and 3 for cells X and Y, respectively) to use to receive DL transmissions in the absence of contrary indications. When the indicated, or activated, TCI codepoint is associated with more than one unified TCI state, an additional indication may be used to specify a particular one, or both, of the unified TCI states. For example, a scheduling DCI (e.g., a grant of DL resources via an sDCI or mDCI) may include a TCI-selection field 551 and an associated value 553 indicating to use unified TCI state 5 (e.g., using a value ‘00’), unified TCI state 3 (e.g., using a value ‘01’), or both unified TCI state 5 and unified TCI state 3 (e.g., using a value ‘10’).

Accordingly, for a unified TCI framework for mTRP applications associated with a grant for resources associated with multiple TRPs, the grant (e.g., a single downlink control information (DCI) (sDCI)) may be received from a single TRP of multiple TRPs, or multiple grants (e.g., multiple DCI (mDCI)) may be received from multiple TRPs. In some aspects, a grant (e.g., an sDCI) received from a single TRP of multiple TRPs may include a 2-bit TCI-selection field to identify at least one TCI state (e.g., one unified TCI state from a set of two unified TCI states associated with an indicated TCI codepoint) associated with the multiple TRPs. The 2-bit TCI-selection field, in some aspects, may be configured by RRC to be present in the grant (e.g., an sDCI format based on DCI format 1_1 or DCI format 1_2) scheduling (or activating) physical DL shared channel (PDSCH) reception (including dynamic PDSCH and SPS PDSCH) or an aperiodic (AP) channel state information (CSI) RS (AP CSI-RS). In some aspects, the 2-bit TCI-selection field of the grant (e.g., the sDCI) being equal to “00” may indicate for a wireless device to apply the first of two indicated joint, or DL, TCI states to each PDSCH DMRS port(s) of corresponding PDSCH transmission (or AP CSI-RS) occasions(s) scheduled (or activated) by the grant (e.g., the sDCI using DCI format 1_1 or DCI format 1_2). Similarly, the 2-bit TCI-selection field of the grant (e.g., an sDCI) being equal to “01” may indicate for a wireless device to apply the second of two indicated joint, or DL, TCI states to each PDSCH DMRS port(s) of corresponding PDSCH transmission (or AP CSI-RS) occasions(s) scheduled (or activated) by the grant (e.g., the sDCI using DCI format 1_1 or DCI format 1_2). Additionally, in some aspects, the 2-bit TCI-selection field of the grant (e.g., an sDCI) being equal to “10” may indicate for a wireless device to apply both indicated joint, or DL, TCI states to the PDSCH reception (e.g., the DMRS port(s) of corresponding PDSCH transmission (or AP CSI-RS) occasions(s)) scheduled (or activated) by the grant (e.g., the sDCI using DCI format 1_1 or DCI format 1_2). While specific values that may be used for the 2-bit TCI-selection field are discussed above, some aspects may use different values (e.g., a different mapping of values) to indicate which TCI state(s) to apply for a PDSCH occasion scheduled by a grant including the 2-bit TCI-selection field and may indicate at least one additional behavior. In some aspects, the 2-bit TCI selection field may be a component of a multi-bit field or indication associated with additional aspects of scheduled DL transmissions in an mTRP environment.

The selection of the unified TCI state from a set of two unified TCI states indicated in a TCI codepoint (e.g., by reference to a unified TCI state pool for DL (either a joint DL/UL, or separate DL, unified TCI state pool) described above) may apply to the scheduled (or activated) PDSCH reception when the offset between the reception of the scheduling grant (e.g., the sDCI using, for example, DCI format 1_1 or DCI format 1_2) and the scheduled (or activated) PDSCH reception is equal to or larger than a threshold (e.g., a threshold similar to timeDurationForQCL that may be configured for the mTRP application or associated with an sDCI).

However, in some aspects, the DL transmission scheduled in a grant (e.g., scheduling DCI 550) may occur before a threshold time from the reception of the scheduling DCI 550 such that the wireless device receiving the TCI selection indication may not be configured to use the unified TCI state(s) indicated in the scheduling DCI 550.

Various aspects of the disclosure relate generally to selecting a default beam for reception of DL transmissions within a threshold amount of time (e.g., a threshold shorter than, or similar to, timeDurationForQCL that may be configured for the mTRP application or associated with an sDCI) following a reception of control information scheduling the DL transmissions (e.g., a grant such as an sDCI or mDCI). Some aspects more specifically relate to selecting (or using), at a wireless device supporting a single default TCI state (or beam), a default TCI state (or beam) for receiving DL transmissions (e.g., PDSCH or CSI-RS) associated with mTRP DL transmissions within the threshold amount of time following the control information. Accordingly, aspects of the disclosure may allow a base station (e.g., a base station including one or more of the multiple TRPs) and a connected wireless device to select a same TCI state (or related TCI states) (e.g., unified TCI state(s) associated, or QCL, with a particular beam, or beams) for a DL transmission scheduled within a threshold time of (transmission and/or reception of) a grant scheduling the DL transmission. The DL transmission, in some aspects, may be a PDSCH or an AP CSI-RS.

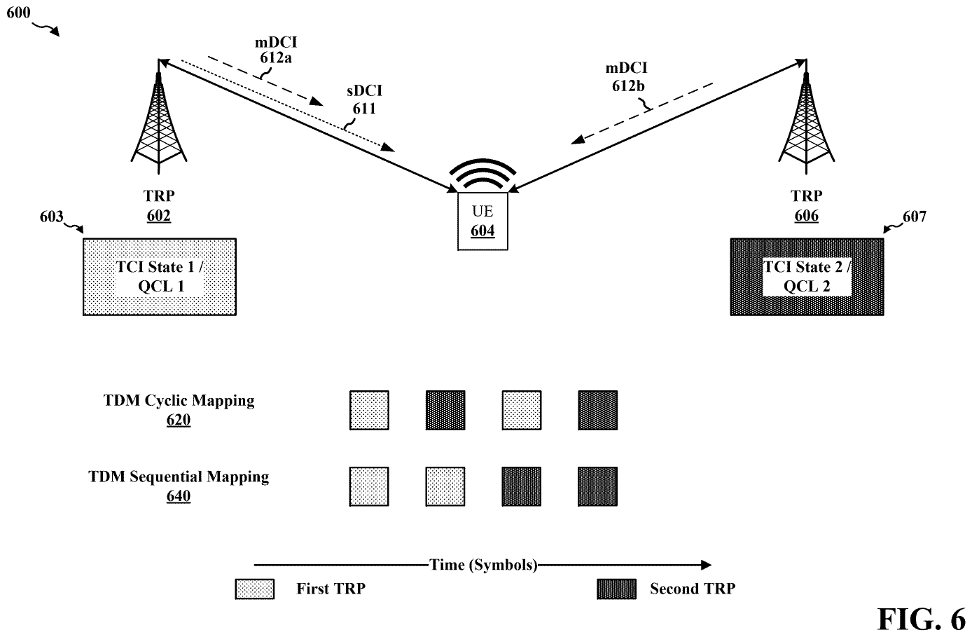

As described above, in some aspects of wireless communication, multiple TRPs may communicate with a single wireless device and/or a single wireless device may communicate with multiple TRPs. In some aspects, mTRP communication may be scheduled with an sDCI transmitted by one of the TRPs or by multiple DCI (mDCI) transmitted by multiple TRPs. FIG. 6 includes a diagram 600 illustrating an example in which a first TRP 602 sends, to a UE 604, an sDCI 611 with scheduling information for downlink communication, such as PDSCH or AP CSI-RS, from the first TRP 602 and the second TRP 606. In some aspects, the mTRP communication may be scheduled by multiple DCI (mDCI), e.g., from the different TRPs. For example, diagram 600 also shows an example in which the TRP 602 sends, to the UE 604, a DCI 612a (e.g., a first DCI in a set of mDCI) scheduling downlink communication, e.g., PDSCH or AP CSI-RS, from the TRP 602, and the TRP 606 sends, to the UE 604, DCI 612b (e.g., a second DCI in the set of mDCI) scheduling downlink communication from the TRP 606. Thus, control and/or data signaling from the TRPs may overlap in time, frequency, and/or spatial directions.

As illustrated, the first TRP 602 may be associated with a first TCI state 603 (e.g., QCL with a first reference signal) and the second TRP 606 may be associated with a second TCI state 607 (e.g., QCL with a second reference signal). Diagram 600 further illustrates that multiple TRPs may coordinate to multiplex communications for at least one UE (e.g., the UE 604) using TDM. The TDM may be based on cyclic mapping (e.g., TDM cyclic mapping 620) in which resources for different TRPs are interspersed. Alternatively, or additionally, the TDM may be based on sequential mapping (e.g., TDM sequential mapping 640) in which resources for different TRPs are scheduled in consecutive resources. For example, For the mDCI example, HARQ ACK/NACK feedback for the different TRPs may be based on a single codebook or may be based on different codebooks. In some aspects, PDCCH from multiple TRPs may be transmitted with repetition having different QCL relationships. In some aspect, PUSCH or PUCCH may be transmitted to multiple TRPs in a TDM manner with repetition, or may be simultaneously transmitted with SDM.

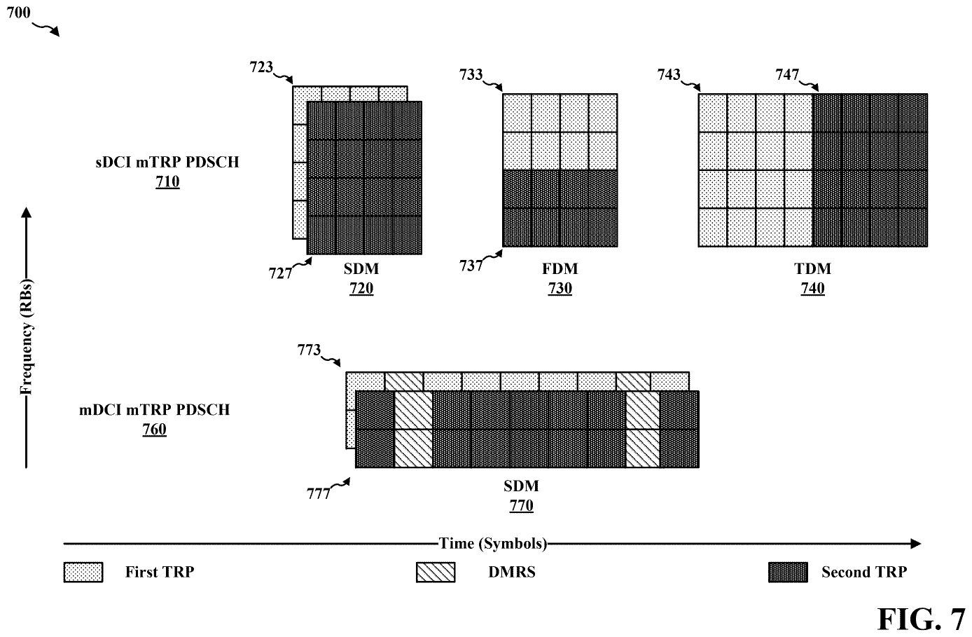

FIG. 7 is a diagram 700 illustrating that for mTRP PDSCH, one or more of SDM, FDM, or TDM may be employed for the PDSCHs from different TRPs in accordance with some aspects of the disclosure. For example, for mTRP PDSCH scheduled via sDCI 710 the resources for the different TRPs may use SDM 720 for transmissions associated with overlapping resources 723 associated with a first TRP and resources 727 associated with a second TRP. Alternatively, or additionally, the resources for the different TRPs may use FDM 730 for transmissions associated with separate frequency resources 733 associated with the first TRP and resources 737 associated with the second TRP. Alternatively, or additionally, the resources for the different TRPs may use TDM 740 for transmissions associated with separate temporal resources 743 associated with the first TRP and resources 747 associated with the second TRP. Similarly, for mTRP PDSCH scheduled via mDCI 760 the resources for the different TRPs may use any of SDM, FDM, or TDM. Diagram 700 illustrates an example using SDM 770 for transmissions associated with overlapping resources 773 associated with a first TRP and resources 777 associated with a second TRP scheduled via mDCI 760 where the resources 773 may be scheduled by a DCI in a set of mDCI transmitted by (or received from) the first TRP and where the resources 777 may be scheduled by a DCI in a set of mDCI transmitted by (or received from) the second TRP.

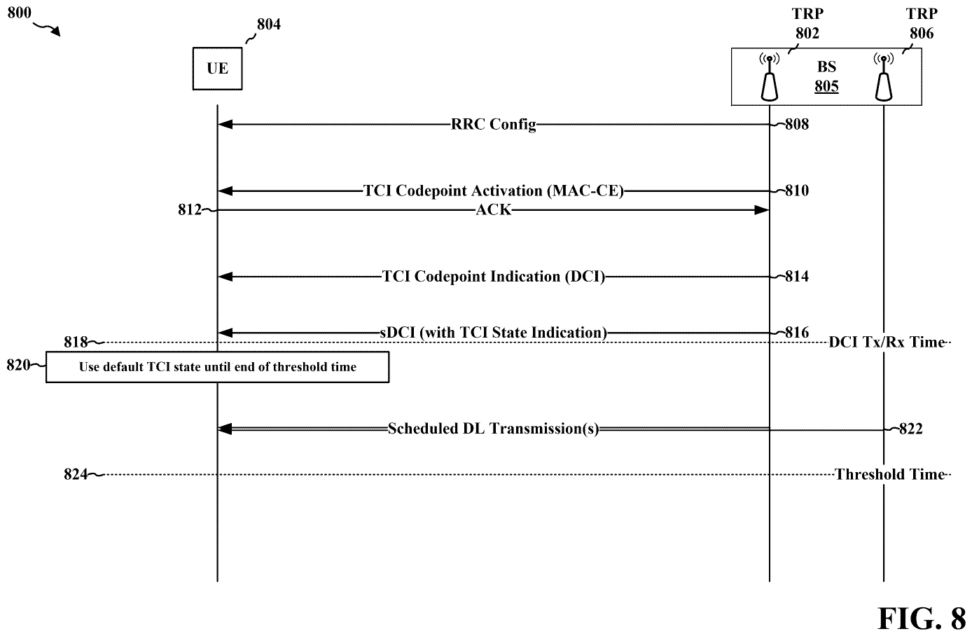

FIG. 8 is a call flow diagram 800 illustrating a method for identifying, selecting, and/or determining a default TCI state for receiving at least one DL transmission for each of multiple TRPs within a time period after receiving control information scheduling the at least one DL transmission for each of multiple TRPs in accordance with some aspects of the disclosure. Call flow diagram 800 illustrates an mTRP environment including a UE 804 communicating with a first TRP 802 (e.g., a serving cell) and a second TRP 806 (e.g., a secondary cell). In some aspects, the first TRP 802 and the second TRP 806 may be associated with a same base station 805 (or network device) as shown (or with a different base station as illustrated in call flow diagram 900). Call flow diagram 800 illustrates that the TRP 802, in some aspects, may transmit, and the UE 804 may receive, RRC configuration 808. The RRC configuration 808, in some aspects, may include an indication (e.g., such as tci-StatesToAddModList 509 of FIG. 5) of a set (or list) of unified TCI states that are capable of being activated in subsequent control information (e.g., a tci-StatesToAddModList including a list of ‘TCI-Stated’ s).

An initial configuration may include additional transmissions from one or more of the TRP 802, the UE 804, or the TRP 806 that may be associated with configuring a time threshold or other aspects of the communication as discussed below regarding threshold time 824. Specifically, in some aspects, the UE 804 may provide, via the RRC configuration 808 or the additional transmissions, one or more values specifying a minimum number of OFDM symbols for the UE 804 to perform PDCCH reception and apply spatial QCL information received in DCI for PDSCH processing (or reception). In some aspects, the UE 804 may indicate one value of the minimum number of OFDM symbols per each subcarrier spacing of 60 kHz and 120 kHz via the RRC configuration 808 or the additional transmissions. The minimum number of OFDM symbols, in some aspects, may be used to determine a configured threshold time for applying an indicated TCI state selection (e.g., similar to timeDurationForQCL for application of a default beam to receive a PDSCH or CSI-RS from a single TRP).

The TRP 802, in some aspects, may transmit (or provide), and the UE 804 may receive, a TCI codepoint (CP) activation 810 (e.g., via a MAC-CE). The TCI CP activation 810, in some aspects, may be an activation/deactivation MAC-CE (e.g., similar to the TCI activation indication 521 or the TCI activation indication 522) identifying an associated cell and/or resources (e.g., a BWP and/or CC), e.g., in a first octet (e.g., “Oct 1”), and indicating a set of activated unified TCI states associated with TCI CPs, e.g., via a bitmap included in a set of additional octets (e.g., “Oct 2” through “Oct N”) that maps to the set (or list) of unified TCI states that are capable of being activated indicated in the RRC configuration 808. While the TCI CP activation 810 is illustrated as a single transmission from the TRP 802 to the UE 804, additional TCI CP activations (e.g., as illustrated in relation to the set of TCI activation messages 520 or the TCI CP activation(s) 910 described below) or TCI-state-related MAC-CEs (or layer 2 messages) (e.g., indicating one or more additional unified TCI state(s) associated with one or more CORESETs) may be provided by the TRP 802 and/or the TRP 806 to the UE 804.

Based on the TCI CP activation 810 (e.g., an activation/deactivation MAC-CE, such as the TCI activation indication 521 or the TCI activation indication 522), the UE 804 may maintain a list (e.g., an indexed/ordered list) of active TCI states (e.g., a set of codepoints or active TCI codepoints such as the combined set of TCI codepoints 523, the set of TCI codepoints 527, and/or the set of TCI codepoints 529). The list of active TCI states (or TCI codepoints), in some aspects, may be associated with a smaller maximum number of TCI states than the set (or list) of unified TCI states that are capable of being activated in subsequent control information. For example, the set (or list) of TCI states indicated by, or included in, RRC configuration 808 may include a maximum of 128 (or M) TCI states (e.g., ‘TCI-StateId’s), while the list of active TCI states (e.g., the combined set of TCI codepoints 523, the set of TCI codepoints 527, and/or the set of TCI codepoints 529) may include a maximum of 8 (or L, where L<M) values. In some aspects, the values in the list of active TCI codepoints may include an index into the set (or list) of unified TCI states indicated by the RRC configuration 808. In response to the TCI CP activation 810, the UE 804 may transmit, and the first TRP 802 may receive, and acknowledgement (ACK) 812, indicating that the UE 804 has received the TCI CP activation 810 and that the indicated TCI codepoints and/or unified TCI states may be used for receiving DL transmissions.

Based on the TCI codepoints (e.g., the set of activated unified TCI states associated with TCI CPs) configured by the TCI CP activation 810, the TRP 802 may transmit, and UE 804 may receive, a TCI codepoint indication 814 (e.g., via DCI) indicating a TCI codepoint associated with a unified TCI state to use for subsequent DL transmissions. While illustrated as a single indication, the TCI codepoint indication 814 may be a set of multiple TCI-state-related DCIs (or other layer 2 or 3 messages) indicating one or more unified TCI states associated with one or more channels, CORESETs, or BWPs in addition to the unified TCI state(s) associated with the TCI codepoint indicated by the TCI codepoint indication 814. For example, a first TCI-state-related DCI associated with the TCI codepoint indication 814 may indicate a (unified) TCI state associated with transmissions associated with a first set of channels including, for example, PDSCH transmissions or AP CSI-RS (e.g., DL transmissions 822), and an additional TCI-state-related DCI associated with the TCI codepoint indication 814 may indicate a (unified) TCI state for one or more other channels, for example, one or more CORESETs. In some aspects, the one or more other channels may be explicitly, or implicitly, indicated to be excluded from the first set of channels in either the first TCI-state-related DCI or by the additional TCI-state-related DCI. For a UE supporting mTRP operation, one or more TCI codepoints associated with the TCI CP activation 810 (e.g., TCI codepoints 524 or 525 of the combined set of TCI codepoints 523) may be associated with multiple unified TCI states. In some aspects, this ambiguity may be clarified for a particular DL transmission (or set of DL transmissions) in a grant scheduling the particular DL transmission(s).

For example, a TRP 802 may transmit, and the UE 804 may receive, sDCI 816 scheduling one or more DL transmissions from one or more of the TRP 802 and the TRP 806. The sDCI 816, in some aspects, may include a TCI-selection field (e.g., a field similar to the TCI-selection field 551) indicating whether to use a first unified TCI state associated with the TCI codepoint, a second unified TCI state associated with the TCI codepoint, or both the first unified TCI state and the second unified TCI state associated with the TCI codepoint to receive the scheduled DL transmission(s). However, if the DL transmission(s), such as DL transmissions 822, are scheduled for a time period between a first time 818 associated with the transmission (or reception) of the sDCI and a threshold time 824 (e.g., a configured threshold time similar to a time-duration-for-quasi-co-location (QCL) threshold, or, timeDurationForQCL) after the first time 818, the one or more unified TCI state(s) indicated by the TCI-selection field may not be used and, instead, a default TCI state may be used.

Accordingly, after receiving the sDCI 816, the UE 804 may, at 820, use a default unified TCI state to receive the DL transmission(s) scheduled by the sDCI 816 until the threshold time 824. In some aspects, the UE 804 may be configured to use, or may support, a single default TCI state. As opposed to the case in which an active TCI codepoint (e.g., a TCI codepoint indicated in a TCI codepoint indication such as TCI codepoint indication 814) is associated with a single TCI state value (unified or otherwise) which may be used as the default, for a case in which a TCI codepoint is associated with multiple unified TCI states, it may not be clear which unified TCI state to use as a default state. For example, for unified TCI state extension to sDCI based mTRP, if two indicated TCIs (e.g., unified TCI states) in a TCI codepoint are maintained by the UE 804 and the UE 804 supports a single default beam for a scheduling offset between the reception of the scheduling DCI (e.g., sDCI using DCI format 1_1 or DCI format 1_2) and the scheduled/activated DL transmission (e.g., PDSCH/AP-CSI) reception that is smaller than the threshold, the UE 804 may select a default TCI state to use for reception of the scheduled DL transmission. Accordingly, multiple options for selecting the default unified TCI state are provided.

In a first aspect, the TRP 802 or the TRP 806 may provide an indication of a default unified TCI state to use for receiving a DL transmission within a threshold amount of time following control information (e.g., DCI, sDCI, or mDCI) scheduling the DL transmission. For example, the indication of the default unified TCI state may be included in any of the RRC configuration 808, the TCI CP activation 810, or the TCI codepoint indication 814 or may be via separate transmissions (not shown) via RRC, MAC-CE, or DCI.

In some aspects, the default unified TCI state may be selected based on a configured ‘rule’ or criteria. For example, the default unified TCI state associated with a TCI codepoint indicating two unified TCI states may be the first indicated unified TCI state. In some aspects, the rule, or criteria, used may be based on other characteristics of the unified TCI states, such as a PCI associated with the unified TCI state. For example, if the two unified TCI states correspond to different PCIs, the UE 804 may be configured to select the unified TCI state corresponding to the PCI of a serving cell of the UE 804 (e.g., a serving cell associated with one of TRP 802 or TRP 806) as a default unified TCI state.

The default unified TCI state, in some aspects, may be selected by the UE 804 based on being a unified TCI state associated with a CORESET having a lowest CORESET ID. In some aspects, the default unified TCI state, in some aspects, may be selected by the UE 804 based on being a unified TCI state associated with a CORESET associated with a PCI of the serving cell of the UE 804 (e.g., when different CORESETs are associated with different PCIs). The criteria (and ‘rules’) discussed above are non-limiting examples of criteria (or ‘rules’) that may be used to select a default unified TCI state from a plurality of unified TCI states associated with a particular wireless device that supports a single default TCI state.

In some aspects, a combination of the above methods of selectin the default unified TCI states may be used, associated with a priority. For example, a first determination may be made to determine if there is a single unified TCI state that is associated with CORESETs associated with a PCI for a serving cell, and may select such a unified TCI state if it exists. However, if there are multiple unified TCI states associated with CORESETs associated with a PCI for a serving cell, the UE 804 may select the unified TCI state associated with a CORESET having a lowest CORESET ID from among the multiple unified TCI states associated with CORESETs associated with the PCI of the serving cell. The previous example is presented as a non-limiting example for combining criteria and/or ‘rules’ for selecting a default unified TCI state from a plurality of unified TCI states associated with a particular wireless device that supports a single default TCI state.

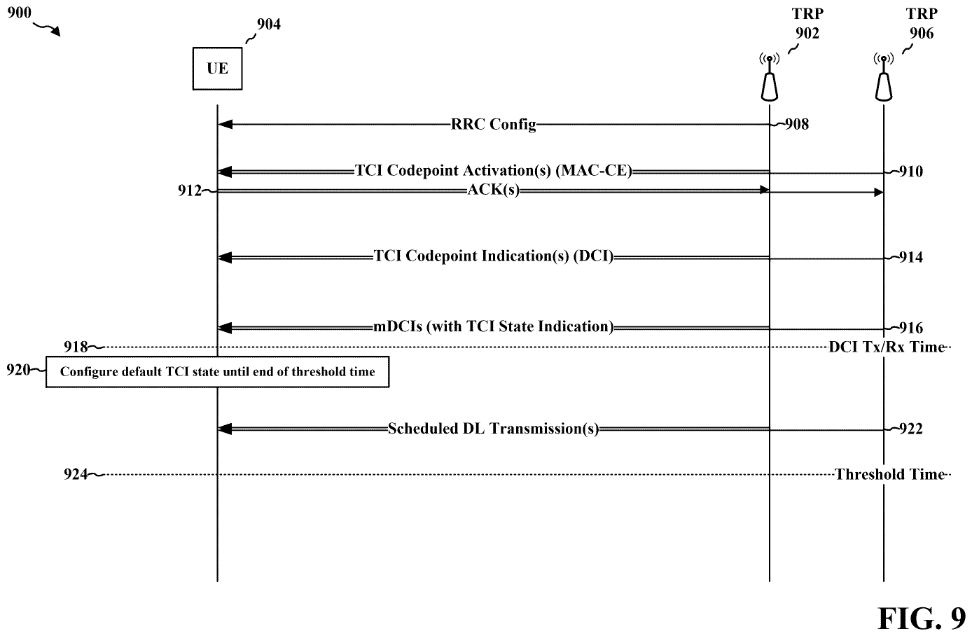

FIG. 9 is a call flow diagram 900 illustrating a method for identifying, selecting, and/or determining a default TCI state for receiving at least one DL transmission for each of multiple TRPs within a time period after receiving control information scheduling the at least one DL transmission for each of multiple TRPs in accordance with some aspects of the disclosure. Call flow diagram 900 illustrates an mTRP environment including a UE 904 communicating with a first TRP 902 (e.g., a serving cell) and a second TRP 906 (e.g., a secondary cell). In some aspects, the first TRP 902 and the second TRP 906 may be associated with different base stations (or network device) as shown (or with a same base station as illustrated in call flow diagram 800). Call flow diagram 900 illustrates that the TRP 902, in some aspects, may transmit, and the UE 904 may receive, RRC configuration 908. The RRC configuration 908, in some aspects, may include an indication (e.g., such as tci-StatesToAddModList 509 of FIG. 5) of a set (or list) of unified TCI states that are capable of being activated in subsequent control information (e.g., a tci-StatesToAddModList including a list of ‘TCI-StateId’s).

An initial configuration may include additional transmissions from one or more of the TRP 902, the UE 904, or the TRP 906 that may be associated with configuring a time threshold or other aspects of the communication as discussed below regarding threshold time 924. Specifically, in some aspects, the UE 904 may provide, via the RRC configuration 908 or the additional transmissions, one or more values specifying a minimum number of OFDM symbols for the UE 904 to perform PDCCH reception and apply spatial QCL information received in DCI for PDSCH processing (or reception). In some aspects, the UE 904 may indicate one value of the minimum number of OFDM symbols per each subcarrier spacing of 60 kHz and 120 kHz via the RRC configuration 908 or the additional transmissions. The minimum number of OFDM symbols, in some aspects, may be used to determine a configured threshold time for applying an indicated TCI state selection (e.g., similar to timeDurationForQCL for application of a default beam to receive a PDSCH or CSI-RS from a single TRP).

The TRP 902 and the TRP 906, in some aspects, may each transmit (or provide), and the UE 904 may receive, a TCI CP activation in a set of TCI CP activation(s) 910 (e.g., via one or more MAC-CEs). The set of TCI CP activation(s) 910, in some aspects, may include activation/deactivation MAC-CEs (e.g., similar to the TCI activation indication 521 or the TCI activation indication 522) identifying an associated cell and/or resources (e.g., a BWP and/or CC), e.g., in a first octet (e.g., “Oct 1”), and indicating a set of activated unified TCI states associated with TCI CPs, e.g., via a bitmap included in a set of additional octets (e.g., “Oct 2” through “Oct N”) that maps to the set (or list) of unified TCI states that are capable of being activated indicated in the RRC configuration 908. While the set of TCI CP activation(s) 910 is illustrated as a single transmission from each of the TRP 902 and the TRP 906 to the UE 904, additional TCI CP activations or TCI-state-related MAC-CEs (or layer 2 messages) (e.g., indicating one or more additional unified TCI state(s) associated with one or more CORESETs) may be provided by the TRP 902 and/or the TRP 906 to the UE 904.

Based on the set of TCI CP activation(s) 910 (e.g., including at least one activation/deactivation MAC-CE, such as the TCI activation indication 521 or the TCI activation indication 522), the UE 904 may maintain a list (e.g., an indexed/ordered list) of active TCI states (e.g., a set of codepoints or active TCI codepoints such as the combined set of TCI codepoints 523, the set of TCI codepoints 527, and/or the set of TCI codepoints 529). The list of active TCI states (or TCI codepoints), in some aspects, may be associated with a smaller maximum number of TCI states than the set (or list) of unified TCI states that are capable of being activated in subsequent control information. For example, the set (or list) of TCI states indicated by, or included in, RRC configuration 908 may include a maximum of 128 (or M) TCI states (e.g., ‘TCI-StateId's), while the list of active TCI states (e.g., the combined set of TCI codepoints 523, the set of TCI codepoints 527, and/or the set of TCI codepoints 529) may include a maximum of 9 (or L, where L<M) values. In some aspects, the values in the list of active TCI codepoints may include an index into the set (or list) of unified TCI states indicated by the RRC configuration 908. In response to the set of TCI CP activation(s) 910, the UE 904 may transmit, and the first TRP 902 may receive, a corresponding set of ACKs 912, indicating that the UE 904 has received the set of TCI CP activation(s) 910 and that the indicated TCI codepoints and/or unified TCI states may be used for receiving DL transmissions.

Based on the TCI codepoints (e.g., the set of activated unified TCI states associated with TCI CPs) configured by the set of TCI CP activation(s) 910, the TRP 902 and the TRP 906 may each transmit, and UE 904 may receive, a TCI codepoint indication in a set of TCI codepoint indication(s) 914 (e.g., via DCI) indicating a TCI codepoint associated with a unified TCI state to use for subsequent DL transmissions associated with the TRP 902 and 906, respectively. While illustrated as a single indication from each of the TRP 902 and the TRP 906, the set of TCI codepoint indication(s) 914 may include additional TCI-state-related DCIs (or other layer 2 or 3 messages) indicating one or more unified TCI states associated with one or more channels, CORESETs, or BWPs in addition to the unified TCI state(s) associated with the TCI codepoint indicated by the set of TCI codepoint indication(s) 914. For example, a first TCI-state-related DCI associated with the set of TCI codepoint indication(s) 914 may indicate a (unified) TCI state associated with transmissions associated with a first set of channels including, for example, PDSCH transmissions or AP CSI-RS (e.g., DL transmissions 922), and an additional TCI-state-related DCI associated with the set of TCI codepoint indication(s) 914 may indicate a (unified) TCI state for one or more other channels, for example, one or more CORESETs. In some aspects, the one or more other channels may be explicitly, or implicitly, indicated to be excluded from the first set of channels in either the first TCI-state-related DCI or by the additional TCI-state-related DCI. For a UE supporting mTRP operation, one or more TCI codepoints associated with the set of TCI CP activation(s) 910 (e.g., TCI codepoints 524 or 525 of the combined set of TCI codepoints 523) may be associated with multiple unified TCI states. In some aspects, this ambiguity may be clarified for a particular DL transmission (or set of DL transmissions) in a grant scheduling the particular DL transmission(s).

For example, a TRP 902 and/or a TRP 906 may each transmit, and the UE 904 may receive, a DCI in a set of mDCI 916 scheduling one or more DL transmissions from one or more of the TRP 902 and the TRP 906, respectively. Each DCI in the set of mDCI 916, in some aspects, may explicitly, or implicitly (e.g., by omitting an indication), indicate a TCI codepoint (and associated unified TCI state) for receiving the DL transmission(s) scheduled in the DCI of the set of mDCI 916. However, if the DL transmission(s), such as DL transmissions 922, are scheduled for a time period between a first time 918 associated with the transmission (or reception) of the mDCI and a threshold time 924 (e.g., a configured threshold time similar to a time-duration-for-quasi-co-location (QCL) threshold, or, timeDurationForQCL) after the first time 918, the one or more unified TCI state(s) indicated by the DCI of the set of mDCI 916 may not be used and, instead, a default TCI state may be used. While FIGS. 8 and 9 use the threshold time timeDurationForQCL as an example of a threshold time that may be used in some aspects, the threshold time used in some other aspects, may be defined or configured differently and may take a different value or different values.

Accordingly, after receiving the set of mDCI 916, the UE 904, at 920, may use a default unified TCI state to receive the DL transmission(s) scheduled by the set of mDCI 916 until the threshold time 924. In some aspects, the UE 904 may be configured to use, or may support, a single default TCI state. As opposed to the case in which an active TCI codepoint (e.g., a TCI codepoint indicated in a TCI codepoint indication such as the set of TCI codepoint indication(s) 914) is associated with a single TCI state value (unified or otherwise) which may be used as the default, for a case in which a TCI codepoint is associated with multiple unified TCI states, it may not be clear which unified TCI state to use as a default state. For example, for unified TCI extension to mDCI based mTRP, if two indicated TCIs (e.g., unified TCI states) specific to different CORESET pool index values are maintained by the UE 804, and the UE 804 supports a single default beam for a scheduling offset between the reception of the scheduling DCI (e.g., sDCI using DCI format 1_1 or DCI format 1_2) and the scheduled/activated DL transmission (e.g., PDSCH/AP-CSI) reception that is smaller than the threshold, the UE 804 may select a default TCI state to use for reception of the scheduled DL transmission. Accordingly, multiple options for selecting the default unified TCI state are provided.

In a first aspect, the TRP 902 or the TRP 906 may include an indication of a default unified TCI state to use for receiving a DL transmission within a threshold amount of time following control information (e.g., DCI, sDCI, or mDCI) scheduling the DL transmission. For example, the indication of the default unified TCI state may be included in any of the RRC configuration 908, the set of TCI CP activation(s) 910, or the set of TCI codepoint indication(s) 914 or may be via separate transmissions (not shown) via RRC, MAC-CE, or DCI.

In some aspects, the default unified TCI state may be selected based on a configured ‘rule’ or criteria. For example, if two indicated unified TCI states associated with different CORESET pool index values are maintained by UE, the default unified TCI state may be selected to be the indicated TCI associated with the CORESET pool index 0. In some aspects, the rule, or criteria, used may be based on other characteristics of the unified TCI states, such as a PCI associated with the unified TCI state. For example, if the two indicated unified TCI states correspond to different PCIs, the UE 904 may be configured to select the unified TCI state corresponding to the PCI of the serving cell of the UE 904 (e.g., a serving cell associated with one of TRP 902 or TRP 906) as a default unified TCI state.

The default unified TCI state, in some aspects, may be selected by the UE 904 based on being a unified TCI state associated with a CORESET having a lowest CORESET ID. In some aspects, the default unified TCI state, in some aspects, may be selected by the UE 904 based on being a unified TCI state associated with a CORESET associated with a PCI of the serving cell of the UE 904 (e.g., when different CORESETs are associated with different PCIs). The criteria (and ‘rules’) discussed above are non-limiting examples of criteria (or ‘rules’) that may be used to select a default unified TCI state from a plurality of unified TCI states associated with a particular wireless device that supports a single default TCI state.

In some aspects, a combination of the above methods of selectin the default unified TCI states may be used, associated with a priority. For example, a first determination may be made to determine if there is a single unified TCI state that is associated with CORESETs associated with a PCI for a serving cell, and may select such a unified TCI state if it exists. However, if there are multiple unified TCI states associated with CORESETs associated with a PCI for a serving cell, the UE 904 may select the unified TCI state associated with a CORESET having a lowest CORESET ID from among the multiple unified TCI states associated with CORESETs associated with the PCI of the serving cell. The previous example is presented as a non-limiting example for combining criteria and/or ‘rules’ for selecting a default unified TCI state from a plurality of unified TCI states associated with a particular wireless device that supports a single default TCI state.

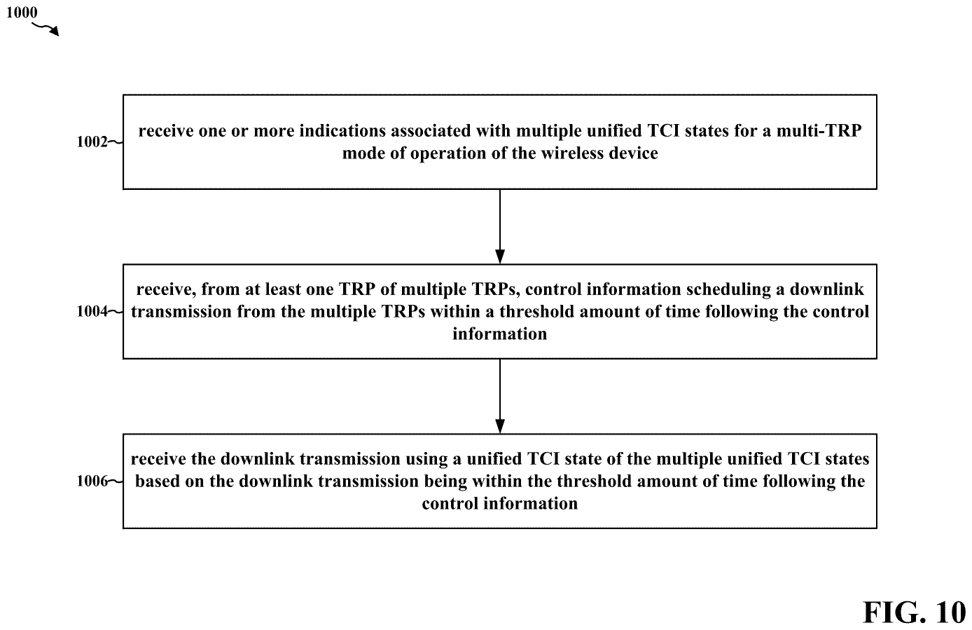

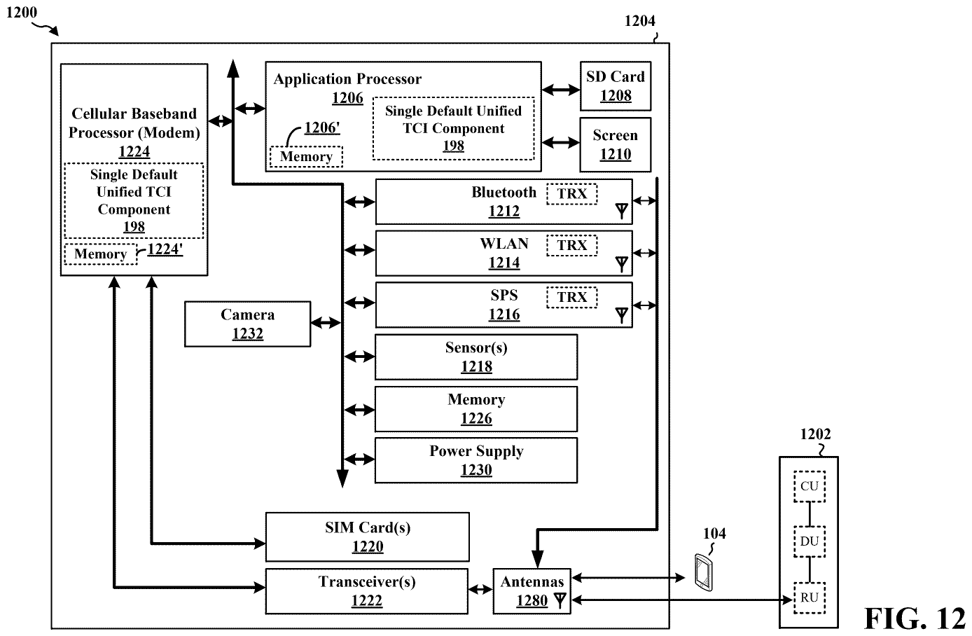

FIG. 10 is a flowchart 1000 of a method of wireless communication. The method may be performed by a UE (e.g., the UE 104, 604, 804, or 904; the apparatus 1204). At 1002, the UE may receive one or more indications associated with multiple unified TCI states for a multi-TRP mode of operation of the wireless device. For example, 1002 may be performed by application processor 1206, cellular baseband processor 1224, transceiver(s) 1222, antenna(s) 1280, and/or single default unified TCI component 198 of FIG. 12. In some aspects, the one or more indications may be received via RRC signaling, a MAC-CE, or DCI. For example, referring to FIGS. 8 and 9, the UE 804 or 904, may receive the RRC configuration 808 or 908, the TCI CP activation 810 or the set of TCI CP activation(s) 910, the TCI codepoint indication 814 or the set of TCI codepoint indication(s) 914.

At 1004, the UE may receive, from at least one TRP of multiple TRPs, control information scheduling a downlink transmission from the multiple TRPs within a threshold amount of time following the control information. For example, 1004 may be performed by application processor 1206, cellular baseband processor 1224, transceiver(s) 1222, antenna(s) 1280, and/or single default unified TCI component 198 of FIG. 12. In some aspects, the UE may receive, before receiving the control information at 1004, a first TCI indication indicating a first TCI codepoint associated with two unified TCI states. The multiple unified TCI states, in some aspects, may be the two unified TCI states associated with the first TCI codepoint, and the control information may include a TCI selection indication indicating to use at least one unified TCI state associated with the first TCI codepoint for receiving the downlink transmission. In some aspects, the UE may receive, before receiving the control information and after receiving the first TCI indication, a second TCI indication indicating an additional unified TCI state associated with a CORESET associated with a lowest identifier.

The UE, in some aspects, may receive, before receiving the control information scheduling the downlink transmission at 1004, an indication to use a (particular) unified TCI state for downlink transmissions scheduled within the threshold amount of time. In some aspects, the threshold amount of time may be a same amount of time as an amount of time associated with a time-duration-for-quasi-co-location (e.g., timeDurationForQCL) threshold for application of a default beam to receive a PDSCH or CSI-RS from a single TRP. The threshold amount of time, in some aspects, may be different amount of time than an amount of time associated with a time-duration-for-quasi-co-location (e.g., timeDurationForQCL) threshold for application of a default beam to receive a PDSCH or CSI-RS from a single TRP. The indication, in some aspects, may be received via one of RRC signaling, a MAC-CE, or DCI. In some aspects, the control information may be a single DCI (e.g., an sDCI) associated with the multiple TRPs. The control information, in some aspects, may include multiple DCIs (e.g., a set of mDCI) from the multiple TRPs. For example, referring to FIGS. 8 and 9, the UE 804 or 904, may receive the TCI codepoint indication 814 or the set of TCI codepoint indication(s) 914 indicating unified TCI states associated with TCI codepoints, or may receive any of the RRC configuration 808 or 908, the TCI CP activation 810 or the set of TCI CP activation(s) 910, the TCI codepoint indication 814 or the set of TCI codepoint indication(s) 914 indicating a particular unified TCI state to use to receive DL transmissions scheduled within the threshold amount of time, and the sDCI 816 or the set of mDCI 916, respectively, scheduling the DL transmissions 822 and the DL transmissions 922, respectively.

At 1006, the UE may receive the downlink transmission using a unified TCI state of the multiple unified TCI states based on the downlink transmission being within the threshold amount of time following the control information. For example, 1006 may be performed by application processor 1206, cellular baseband processor 1224, transceiver(s) 1222, antenna(s) 1280, and/or single default unified TCI component 198 of FIG. 12. The unified TCI state of the multiple unified TCI states used to receive the downlink transmission, in some aspects, may be the (particular) unified TCI state indicated to be used for downlink transmissions scheduled within the threshold amount of time via one of RRC signaling, a MAC-CE, or DCI. For example, referring to FIGS. 8 and 9, the UE 804 or 904, at 820 or 920, may use a default unified TCI state to receive the DL transmission(s) scheduled by the sDCI 816 or the set of mDCI 916, respectively, based on the criteria discussed in relation to FIGS. 8 and 9.

In some aspects, the unified TCI state may be a first indicated unified TCI associated with the first TCI codepoint. The unified TCI state, in some aspects, may be associated with a PCI associated with a cell serving the wireless device. In some aspects, the two unified TCI states associated with the first TCI codepoint may include the unified TCI state associated with the PCI associated with the cell serving the wireless device and a second unified TCI state associated with a second PCI associated with a different cell. The unified TCI state, in some aspects, may be associated with a CORESET associated with a lowest identifier among the two unified TCI states.

The multiple unified TCI states, in some aspects, may include a first unified TCI state associated with a first CORESET pool index value equal to zero and a second unified TCI state associated with a second CORESET pool index value not equal to zero and the unified TCI state may be the first unified TCI state. In some aspects, the multiple unified TCI states may include a first unified TCI state associated with a first CORESET associated with a first PCI associated with a first cell serving the wireless device and a second unified TCI state associated with a second CORESET associated with a second PCI associated with a different cell and the unified TCI state may be the first unified TCI state.

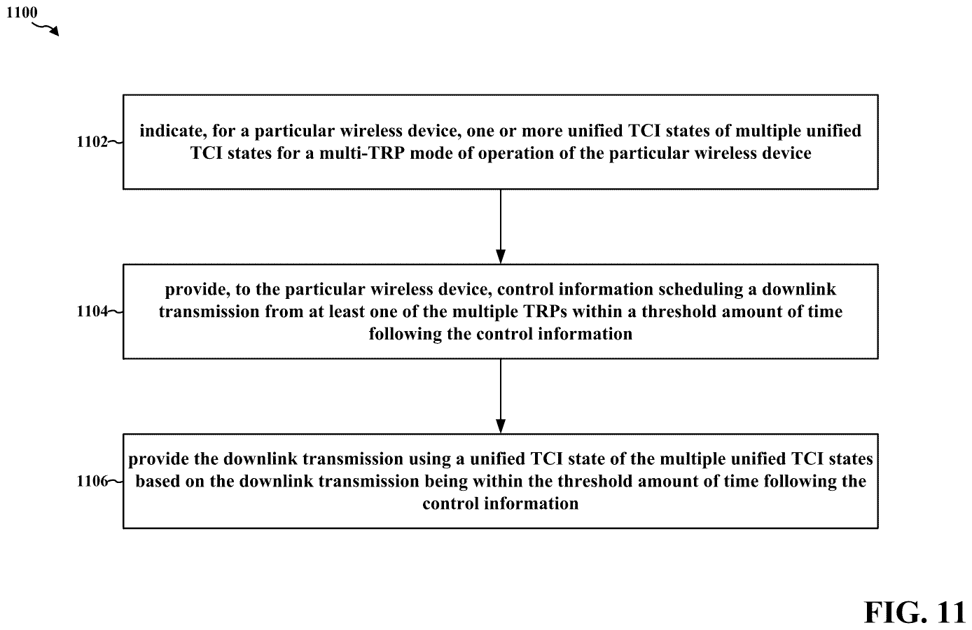

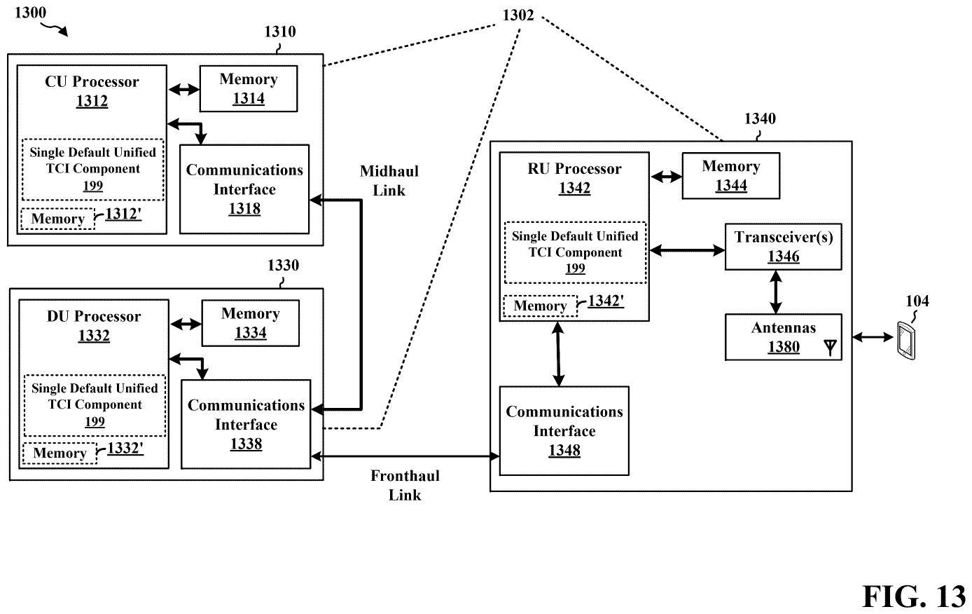

FIG. 11 is a flowchart 1100 of a method of wireless communication. The method may be performed by a TRP or a network device or base station associated with a TRP (e.g., the base station 102; the TRP 602, 606, 802, 806, 902, or 906; the network entity 1202, 1302, 1460). At 1102, the base station may indicate, for a particular wireless device, one or more unified TCI states for a multi-TRP mode of operation of the particular wireless device. For example, 1102 may be performed by CU processor 1312, DU processor 1332, RU processor 1342, transceiver(s) 1346, antenna(s) 1380, and/or single default unified TCI component 199 of FIG. 13. In some aspects, the one or more indications may be indicated, transmitted, or provided via RRC signaling, a MAC-CE, or DCI. For example, referring to FIGS. 8 and 9, the TRP 802 or 902 (and/or the TRP 806 or 906), may indicate one or more unified TCI states for a multi-TRP mode of operation of the UE 804 via the RRC configuration 808 or 908, the TCI CP activation 810 or the set of TCI CP activation(s) 910, the TCI codepoint indication 814 or the set of TCI codepoint indication(s) 914.

At 1104, the TRP may provide, to the particular wireless device, control information scheduling a downlink transmission from at least one of the multiple TRPs within a threshold amount of time following the control information. For example, 1104 may be performed by CU processor 1312, DU processor 1332, RU processor 1342, transceiver(s) 1346, antenna(s) 1380, and/or single default unified TCI component 199 of FIG. 13. In some aspects, the TRP may provide, before providing the control information at 1104, a first TCI indication indicating a first TCI codepoint associated with two unified TCI states. The multiple unified TCI states, in some aspects, may be the two unified TCI states associated with the first TCI codepoint, and the control information may include a TCI selection indication indicating to use at least one unified TCI state associated with the first TCI codepoint for receiving the downlink transmission. In some aspects, the TRP may provide, before providing the control information and after providing the first TCI indication, a second TCI indication indicating an additional unified TCI state associated with a CORESET associated with the lowest identifier.

The TRP, in some aspects, may provide, before providing the control information scheduling the downlink transmission at 1104, an indication for the particular wireless device to use a (particular) unified TCI state as a default (unified) TCI state for downlink transmissions scheduled within the threshold amount of time. In some aspects, the threshold amount of time may be a same amount of time as an amount of time associated with a time-duration-for-quasi-co-location (e.g., timeDurationForQCL) threshold for application of a default beam to receive a PDSCH or CSI-RS from a single TRP. The threshold amount of time, in some aspects, may be different amount of time than an amount of time associated with a time-duration-for-quasi-co-location (e.g., timeDurationForQCL) threshold for application of a default beam to receive a PDSCH or CSI-RS from a single TRP. The indication, in some aspects, may be transmitted (or provided) via one of RRC signaling, a MAC-CE, or DCI. In some aspects, the control information may be a single DCI (e.g., an sDCI) associated with the multiple TRPs. The control information, in some aspects, may include multiple DCIs (e.g., a set of mDCI) from the multiple TRPs. For example, referring to FIGS. 8 and 9, the TRP 802 or 902 (and/or the TRP 806 or 906), may transmit the TCI codepoint indication 814 or the set of TCI codepoint indication(s) 914 indicating unified TCI states associated with TCI codepoints, or may transmit any of the RRC configuration 808 or 908, the TCI CP activation 810 or the set of TCI CP activation(s) 910, the TCI codepoint indication 814 or the set of TCI codepoint indication(s) 914 indicating a particular unified TCI state for the UE 804 or 904 to use to receive DL transmissions scheduled within the threshold amount of time, and the sDCI 816 or the set of mDCI 916, respectively, scheduling the DL transmissions 822 and the DL transmissions 922, respectively.

At 1106, the TRP may provide the downlink transmission using a unified TCI state of the multiple unified TCI states based on the downlink transmission being within the threshold amount of time following the control information. For example, 1106 may be performed by CU processor 1312, DU processor 1332, RU processor 1342, transceiver(s) 1346, antenna(s) 1380, and/or single default unified TCI component 199 of FIG. 13. In some aspects, the unified TCI state used to provide the downlink transmission may be different from, but may be related to, or based on, the unified TCI state used by the particular wireless device to receive the downlink transmission. Accordingly, while described as ‘using the unified TCI state of the multiple TCI states,’ in some aspects, the TRP (and/or a base station associated with the TRP) may use a unified TCI state based on, or related to, the unified TCI state of the multiple unified TCI states. The unified TCI state of the multiple unified TCI states used to transmit (or to receive at the particular wireless device) the downlink transmission, in some aspects, may be the (particular) unified TCI state indicated to be used as a default unified TCI state for downlink transmissions scheduled within the threshold amount of time where the indication may be provided (or transmitted) via one of RRC signaling, a MAC-CE, or DCI. For example, referring to FIGS. 8 and 9, the TRP 802 or 902 (and/or the TRP 806 or 906), may use a default unified TCI state to transmit the DL transmission(s) 822 or 922 scheduled by the sDCI 816 or the set of mDCI 916, respectively, based on the criteria discussed in relation to FIGS. 8 and 9.

In some aspects, the unified TCI state may be a first indicated unified TCI associated with the first TCI codepoint. The unified TCI state, in some aspects, may be associated with a PCI associated with a cell serving the wireless device. In some aspects, the two unified TCI states associated with the first TCI codepoint comprise the unified TCI state associated with the PCI associated with the cell serving the wireless device and a second unified TCI state associated with a second PCI associated with a different cell. The unified TCI state, in some aspects, may be associated with a CORESET associated with a lowest identifier among the two unified TCI states.

The multiple unified TCI states, in some aspects, may include a first unified TCI state associated with a first CORESET pool index value equal to zero and a second unified TCI state associated with a second CORESET pool index value not equal to zero and the unified TCI state may be the first unified TCI state. In some aspects, the multiple unified TCI states may include a first unified TCI state associated with a first CORESET associated with a first PCI associated with a first cell serving the wireless device and a second unified TCI state associated with a second CORESET associated with a second PCI associated with a different cell and the unified TCI state may be the first unified TCI state.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth™ module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth™ module 1212, the WLAN module 1214, and the SPS module 1216 may include an on-chip transceiver (TRX) (or in some cases, just a receiver (RX)). The Bluetooth™ module 1212, the WLAN module 1214, and the SPS module 1216 may include their own dedicated antennas and/or utilize one or more antennas 1280 for communication. The cellular baseband processor 1224 communicates through the transceiver(s) 1222 via the one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 of FIG. 3) and include the additional modules of the apparatus 1204.

As discussed supra, the single default unified TCI component 198 may be configured to receive one or more indications associated with multiple unified TCI states for a multi-TRP mode of operation of the wireless device. The single default unified TCI component 198 may further be configured to receive, from at least one TRP of multiple TRPs, control information scheduling a downlink transmission from the multiple TRPs within a threshold amount of time following the control information and receive the downlink transmission using a unified TCI state of the multiple unified TCI states based on the downlink transmission being within the threshold amount of time following the control information. The single default unified TCI component 198 may be within the cellular baseband processor 1224, the application processor 1206, or both the cellular baseband processor 1224 and the application processor 1206. The single default unified TCI component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, may include means for receiving one or more indications associated with multiple unified TCI states for a multi-TRP mode of operation of the wireless device. The apparatus 1204, and in particular the cellular baseband processor 1224 and/or the application processor 1206, in some aspects, may include means for receiving, from at least one TRP of multiple TRPs, control information scheduling a downlink transmission from the multiple TRPs within a threshold amount of time following the control information.

The apparatus 1204, and in particular the cellular baseband processor 1224 and/or the application processor 1206, in some aspects, may include means for receiving the downlink transmission using a unified TCI state of the multiple unified TCI states based on the downlink transmission being within the threshold amount of time following the control information. The apparatus 1204, and in particular the cellular baseband processor 1224 and/or the application processor 1206, in some aspects, may include means for receiving, before receiving the control information scheduling the downlink transmission, an indication to use the unified TCI state for downlink transmissions scheduled within the threshold amount of time. The apparatus 1204, and in particular the cellular baseband processor 1224 and/or the application processor 1206, in some aspects, may include means for receiving, before receiving the control information, a first TCI indication indicating a first TCI codepoint associated with two unified TCI states. The apparatus 1204, and in particular the cellular baseband processor 1224 and/or the application processor 1206, in some aspects, may include means for receiving, before receiving the control information and after receiving the first TCI indication, a second TCI indication indicating an additional unified TCI state associated with the CORESET associated with the lowest identifier. The means may be the single default unified TCI component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means or any of the operations described in relation to FIG. 10.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the single default unified TCI component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, one or more antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the single default unified TCI component 199 may be configured to indicate, for a particular wireless device, one or more unified TCI states of multiple unified TCI states for a multi-TRP mode of operation of the particular wireless device. The single default unified TCI component 199 may further be configured to provide, to the particular wireless device, control information scheduling a downlink transmission from at least one of the multiple TRPs within a threshold amount of time following the control information and provide the downlink transmission using a unified TCI state of the multiple unified TCI states based on the downlink transmission being within the threshold amount of time following the control information. The single default unified TCI component 199 may be within one or more processors of one or more of the CU 1310, DU 1330, and the RU 1340. The single default unified TCI component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 may include means for indicating, for a particular wireless device, one or more unified TCI states of multiple unified TCI states for a multi-TRP mode of operation of the particular wireless device. In one configuration, the network entity 1302 may include means for providing, to the particular wireless device, control information scheduling a downlink transmission from at least one of the multiple TRPs within a threshold amount of time following the control information. In one configuration, the network entity 1302 may include means for providing the downlink transmission using a unified TCI state of the multiple unified TCI states based on the downlink transmission being within the threshold amount of time following the control information. In one configuration, the network entity 1302 may include means for providing, before providing the control information scheduling the downlink transmission, an indication for the particular wireless device to use the unified TCI state as a default TCI state for downlink transmissions scheduled within the threshold amount of time. In one configuration, the network entity 1302 may include means for providing, before providing the control information, a first TCI indication indicating a first TCI codepoint associated with two unified TCI states. In one configuration, the network entity 1302 may include means for providing, before providing the control information and after providing the first TCI indication, a second TCI indication indicating an additional unified TCI state associated with the CORESET associated with the lowest identifier. The means may be the single default unified TCI component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIG. 11.

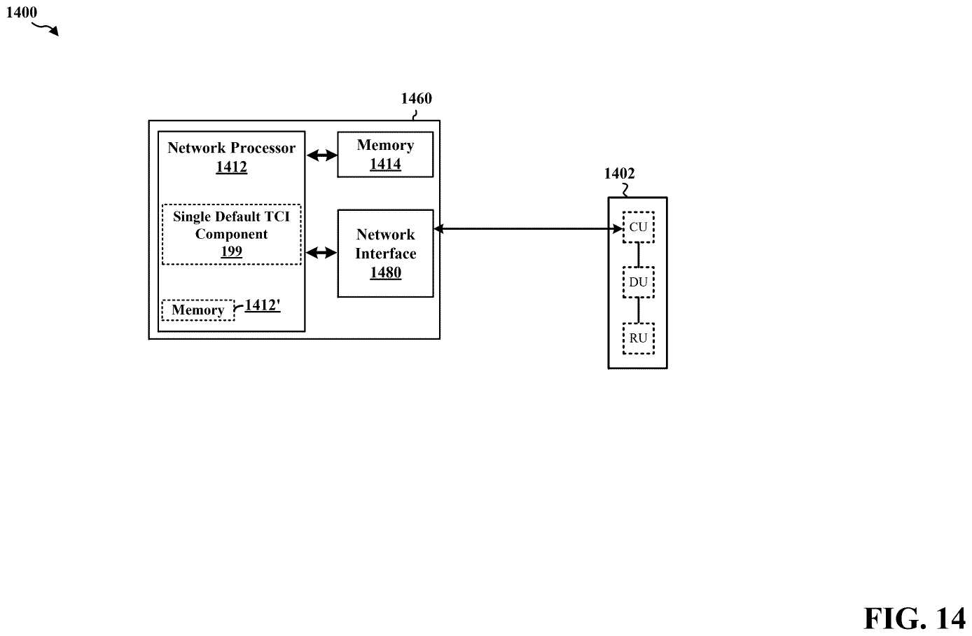

FIG. 14 is a diagram 1400 illustrating an example of a hardware implementation for a network entity 1460. In one example, the network entity 1460 may be within the core network 120. The network entity 1460 may include a network processor 1412. The network processor 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The processor 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the single default unified TCI component 199 may be configured to indicate, for a particular wireless device, one or more unified TCI states of multiple unified TCI states for a multi-TRP mode of operation of the particular wireless device. The single default unified TCI component 199 may further be configured to provide, to the particular wireless device, control information scheduling a downlink transmission from at least one of the multiple TRPs within a threshold amount of time following the control information and provide the downlink transmission using a unified TCI state of the multiple unified TCI states based on the downlink transmission being within the threshold amount of time following the control information. The single default unified TCI component 199 may be within the processor 1412. The single default unified TCI component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 may include means for indicating, for a particular wireless device, one or more unified TCI states of multiple unified TCI states for a multi-TRP mode of operation of the particular wireless device. In one configuration, the network entity 1460 may include means for providing, to the particular wireless device, control information scheduling a downlink transmission from at least one of the multiple TRPs within a threshold amount of time following the control information. In one configuration, the network entity 1460 may include means for providing the downlink transmission using a unified TCI state of the multiple unified TCI states based on the downlink transmission being within the threshold amount of time following the control information. In one configuration, the network entity 1460 may include means for providing, before providing the control information scheduling the downlink transmission, an indication for the particular wireless device to use the unified TCI state as a default TCI state for downlink transmissions scheduled within the threshold amount of time. In one configuration, the network entity 1460 may include means for providing, before providing the control information, a first TCI indication indicating a first TCI codepoint associated with two unified TCI states. In one configuration, the network entity 1460 may include means for providing, before providing the control information and after providing the first TCI indication, a second TCI indication indicating an additional unified TCI state associated with the CORESET associated with the lowest identifier. The means may be the single default unified TCI component 199 of the network entity 1460 configured to perform the functions recited by the means or as described in relation to FIG. 11.

Various aspects of the disclosure relate generally to selecting a default beam for reception of DL transmissions within a threshold amount of time (e.g., a threshold similar to timeDurationForQCL that may be configured for the mTRP application or associated with an sDCI) following a reception of control information scheduling the DL transmissions (e.g., a grant such as an sDCI or mDCI). Some aspects more specifically relate to selecting (or using), at a wireless device supporting a single default TCI state (or beam), a default TCI state (or beam) for receiving DL transmissions (e.g., PDSCH or CSI-RS) associated with mTRP DL transmissions within the threshold amount of time following the control information. Accordingly, aspects of the disclosure may allow a base station (e.g., a base station including one or more of the multiple TRPs) and a connected wireless device to select a same TCI state (or beam) for a DL transmission scheduled within a threshold time of (transmission and/or reception of) a grant scheduling the DL transmission. The DL transmission, in some aspects, may be a PDSCH or an AP CSI-RS. In some aspects, a wireless device may receive one or more indications (e.g., via control information) associated with multiple unified TCI states for a mTRP mode of operation of the wireless device. The wireless device may receive, from at least one TRP of multiple TRPs, control information (e.g., a DCI such as sDCI or mDCI) scheduling a downlink transmission from the multiple TRPs within a threshold amount of time following the control information. In some aspects, the control information may include a TCI selection indication. Based on receiving the control information, the wireless device may receive the DL transmission using a unified TCI state of the multiple TCI states based on the DL transmission being within the threshold amount of time following the control information. The unified TCI state used to receive the DL transmission may be selected as will be described below.

In some aspects, a corresponding network device (e.g., a base station) associated with at least one TRP of the multiple TRPs may indicate, for a particular wireless device, one or more unified TCI states of the multiple unified TCI states for the mTRP mode of operation of the particular wireless device. The network device may additionally, or alternatively, provide, to the particular wireless device, control information (e.g., an sDCI or one of a set of mDCI) scheduling a downlink transmission from at least one of the multiple TRPs within a threshold amount of time following the control information. In some aspects, the control information (e.g., an sDCI) may include the indication of the unified TCI state of the multiple unified TCI states. The network device may provide the downlink transmission using the unified TCI state of the multiple unified TCI states based on the downlink transmission being within the threshold amount of time following the control information. The unified TCI state used for receiving (or transmitting) the downlink transmission may be selected in one of multiple manners as will be described below.

Particular aspects of the subject matter described in this disclosure can be implemented to realize one or more of the following potential advantages. In some examples, by configuring a default-unified-TCI-state selection and/or determination, the described techniques can be used to improve the reception of DL transmission(s) scheduled within a threshold time after control information (e.g., sDCI or mDCI) scheduling the DL transmission(s) by ensuring that the TRP(s) transmitting the DL transmission(s) uses a same TCI state as (or a TCI state related to, or based on, a TCI state used by) the wireless device receiving the DL transmission(s).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, including receiving one or more indications associated with multiple unified TCI states for a multi-TRP mode of operation of the wireless device, receiving, from at least one TRP of multiple TRPs, control information scheduling a downlink transmission from the multiple TRPs within a threshold amount of time following the control information, and receiving the downlink transmission using a unified TCI state of the multiple unified TCI states based on the downlink transmission being within the threshold amount of time following the control information.

Aspect 2 is the method of aspect 1, further including receiving, before receiving the control information scheduling the downlink transmission and via one of RRC signaling, a MAC-CE, or DCI, an indication to use the unified TCI state for downlink transmissions scheduled within the threshold amount of time.

Aspect 3 is the method of any of aspects 1 and 2, further including receiving, before receiving the control information, a first TCI indication indicating a first TCI codepoint associated with two unified TCI states, where the multiple unified TCI states include the two unified TCI states associated with the first TCI codepoint, where the control information includes a TCI selection indication to use at least one unified TCI state associated with the first TCI codepoint for receiving the downlink transmission, and where the control information is an sDCI associated with the multiple TRPs.

Aspect 4 is the method of aspect 3, where the unified TCI state is a first indicated unified TCI associated with the first TCI codepoint.

Aspect 5 is the method of any of aspects 3 and 4, where the unified TCI state is associated with a PCI associated with a cell serving the wireless device.

Aspect 6 is the method of aspect 5, where the two unified TCI states associated with the first TCI codepoint include the unified TCI state associated with the PCI associated with the cell serving the wireless device and a second unified TCI state associated with a second PCI associated with a different cell.

Aspect 7 is the method of any of aspects 3-6, where the unified TCI state is associated with a CORESET associated with a lowest identifier among the two unified TCI states.

Aspect 8 is the method of aspect 7, further including receiving, before receiving the control information and after receiving the first TCJ indication, a second TCJ indication indicating an additional unified TCJ state associated with the CORESET associated with the lowest identifier.

Aspect 9 is the method of any of aspects 1, 2, 7, and 8, where the multiple unified TCJ states include a first unified TCJ state associated with a first CORESET pool index value equal to zero and a second unified TC state associated with a second CORESET pool index value not equal to zero, where the unified TCJ state is the first unified TCJ state, and where the control information includes mDCI from the multiple TRPs.

Aspect 10 is the method of any of aspects 1, 2, and 7-9, where the multiple unified TCJ states include a first unified TCJ state associated with a first CORESET associated with a first PCI associated with a first cell serving the wireless device and a second unified TCJ state associated with a second CORESET associated with a second PCI associated with a different cell and the unified TC state is the first unified TCJ state, and where the control information includes mDCI from the multiple TRPs.

Aspect 11 is the method of any of aspects 1 to 10, where the threshold amount of time is a same amount of time as an amount of time associated with a time-duration-for-quasi-co-location threshold for application of a default beam to receive a PDSCH or CSI-RS from a single TRP.

Aspect 12 is the method of any of aspects 1 to 10, where the threshold amount of time is a different amount of time from an amount of time associated with a time-duration-for-quasi-co-location threshold for application of a default beam to receive a PDSCH or CSI-RS from a single TRP.

Aspect 13 is a method of wireless communication at a network device, including indicating, for a particular wireless device, one or more unified TCJ states of multiple unified TC states for a multi-TRP mode of operation of the particular wireless device, providing, to the particular wireless device, control information scheduling a downlink transmission from at least one of multiple TRPs within a threshold amount of time following the control information, and providing the downlink transmission using a unified TCJ state of the multiple unified TCJ states based on the downlink transmission being within the threshold amount of time following the control information.

Aspect 14 is the method of aspect 13, further including providing, before providing the control information scheduling the downlink transmission and via one of RRC signaling, a MAC-CE, or DCI, an indication for the particular wireless device to use the unified TCI state as a default TCI state for downlink transmissions scheduled within the threshold amount of time.

Aspect 15 is the method of any of aspects 13 and 14, further including providing, before providing the control information, a first TCI indication indicating a first TCI codepoint associated with two unified TCI states, where the multiple unified TCI states include the two unified TCI states associated with the first TCI codepoint, where the control information includes a TCI selection indication to use at least one unified TCI state associated with the first TCI codepoint for receiving the downlink transmission, and where the control information is an sDCI associated with the multiple TRPs.

Aspect 16 is the method of aspect 15, where the unified TCJ state is a first indicated unified TCJ associated with the first TCJ codepoint.

Aspect 17 is the method of any of aspects 15 and 16, where the unified TCJ state is associated with a PCI associated with a cell serving the wireless device.

Aspect 18 is the method of aspect 17, where the two unified TCI states associated with the first TCI codepoint include the unified TCI state associated with the PCI associated with the cell serving the particular wireless device and a second unified TCJ state associated with a second PCI associated with a different cell.

Aspect 19 is the method of any of aspects 15-18, where the unified TCJ state is associated with a CORESET associated with a lowest identifier among the two unified TCI states.

Aspect 20 is the method of aspect 19, further including providing, before providing the control information and after providing the first TCI indication, a second TCI indication indicating an additional unified TCI state associated with the CORESET associated with the lowest identifier.

Aspect 21 is the method of any of aspects 13, 14, 19, and 20, where the multiple unified TCI states include a first unified TCI state associated with a first CORESET pool index value equal to zero and a second unified TCI state associated with a second CORESET pool index value not equal to zero, where the unified TCI state is the first unified TCI state, and where the control information includes downlink control information associated with a single TRP of the multiple TRPs.

Aspect 22 is the method of any of aspects 13, 14, and 19-21, where the multiple unified TCI states include a first unified TCI state associated with a first CORESET associated with a first PCI associated with a first cell serving the wireless device and a second unified TCJ state associated with a second CORESET associated with a second PCI associated with a different cell and the unified TC state is the first unified TCJ state, and where the control information includes downlink control information associated with a single TRP of the multiple TRPs.

Aspect 23 is the method of any of aspects 1 to 22, where the threshold amount of time is a same amount of time as an amount of time associated with a time-duration-for-quasi-co-location threshold for application of a default beam to receive a PDSCH or CSI-RS from a single TRP.

Aspect 24 is the method of any of aspects 1 to 22, where the threshold amount of time is a different amount of time from an amount of time associated with a time-duration-for-quasi-co-location threshold for application of a default beam to receive a PDSCH or CSI-RS from a single TRP.

Aspect 25 is an apparatus for wireless communication at a device including a memory and at least one processor coupled to the memory and, based at least in part on information stored in the memory, the at least one processor is configured to implement any of aspects 1 to 24.

Aspect 26 is the method of aspect 25, further including a transceiver or an antenna coupled to the at least one processor.

Aspect 27 is an apparatus for wireless communication at a device including means for implementing any of aspects 1 to 24.

Aspect 28 is a computer-readable medium (e.g., a non-transitory computer-readable medium) storing computer executable code, where the code when executed by a processor causes the processor to implement any of aspects 1 to 24.

1. An apparatus for wireless communication at a wireless device, comprising:
a memory; and
at least one processor coupled to the memory and, based at least in part on information stored in the memory, the at least one processor is configured to:
receive one or more indications associated with multiple unified transmission configuration indication (TCI) states for a multiple transmission and reception point (multi-TRP) mode of operation of the wireless device;
receive, from at least one TRP of multiple TRPs, control information scheduling a downlink transmission from the multiple TRPs within a threshold amount of time following the control information; and
receive the downlink transmission using a unified TCI state of the multiple unified TCI states based on the downlink transmission being within the threshold amount of time following the control information.

2. The apparatus of claim 1, wherein the at least one processor is further configured to:
receive, before receiving the control information scheduling the downlink transmission and via one of radio resource control (RRC) signaling, a medium access control (MAC) control element (CE) (MAC-CE), or downlink control information (DCI), an indication to use the unified TCI state for downlink transmissions scheduled within the threshold amount of time.

3. The apparatus of claim 1, wherein the at least one processor is further configured to:
receive, before receiving the control information, a first TCI indication indicating a first TCI codepoint associated with two unified TCI states, wherein the multiple unified TCI states comprise the two unified TCI states associated with the first TCI codepoint, wherein the control information includes a TCI selection indication to use at least one unified TCI state associated with the first TCI codepoint for receiving the downlink transmission, and wherein the control information is a single downlink control information (sDCI) associated with the multiple TRPs.

4. The apparatus of claim 3, wherein the unified TCI state is a first indicated unified TCI associated with the first TCI codepoint.

5. The apparatus of claim 3, wherein the unified TCI state is associated with a physical cell identifier (PCI) associated with a cell serving the wireless device.

6. The apparatus of claim 5, wherein the two unified TCI states associated with the first TCI codepoint comprise the unified TCI state associated with the PCI associated with the cell serving the wireless device and a second unified TCI state associated with a second PCI associated with a different cell.

7. The apparatus of claim 3, wherein the unified TCI state is associated with a control resource set (CORESET) associated with a lowest identifier among the two unified TCI states.

8. The apparatus of claim 7, wherein the at least one processor is further configured to:
receive, before receiving the control information and after receiving the first TCI indication, a second TCI indication indicating an additional unified TCI state associated with the CORESET associated with the lowest identifier.

9. The apparatus of claim 1, wherein the multiple unified TCI states comprise a first unified TCI state associated with a first control resource set (CORESET) pool index value equal to zero and a second unified TCI state associated with a second CORESET pool index value not equal to zero, wherein the unified TCI state is the first unified TCI state, and wherein the control information comprises multiple downlink control information (mDCI) from the multiple TRPs.

10. The apparatus of claim 1, wherein the multiple unified TCI states comprise a first unified TCI state associated with a first control resource set (CORESET) associated with a first physical cell identifier (PCI) associated with a first cell serving the wireless device and a second unified TCI state associated with a second CORESET associated with a second PCI associated with a different cell and the unified TCI state is the first unified TCI state, and wherein the control information comprises multiple downlink control information (mDCI) from the multiple TRPs.

11. The apparatus of claim 1, further comprising a transceiver coupled to the at least one processor, the transceiver being configured to receive the downlink transmission using the unified TCI state of the multiple unified TCI states based on the downlink transmission being within the threshold amount of time following the control information, wherein the threshold amount of time is a same amount of time as an amount of time associated with a time-duration-for-quasi-co-location (QCL) threshold for application of a default beam to receive a physical downlink shared channel (PDSCH) or channel state information reference signal (CSI-RS) from a single TRP.

12. The apparatus of claim 1, further comprising a transceiver coupled to the at least one processor, the transceiver being configured to receive the downlink transmission using the unified TCI state of the multiple unified TCI states based on the downlink transmission being within the threshold amount of time following the control information, wherein the threshold amount of time is a different amount of time from an amount of time associated with a time-duration-for-quasi-co-location (QCL) threshold for application of a default beam to receive a physical downlink shared channel (PDSCH) or channel state information reference signal (CSI-RS) from a single TRP.

13. An apparatus for wireless communication at a network device, comprising:
a memory; and
at least one processor coupled to the memory and, based at least in part on information stored in the memory, the at least one processor is configured to:
indicate, for a particular wireless device, one or more unified transmission configuration indication (TCI) states of multiple unified TCI states for a multiple transmission and reception point (multi-TRP) mode of operation of the particular wireless device;
provide, to the particular wireless device, control information scheduling a downlink transmission from at least one of multiple TRPs within a threshold amount of time following the control information; and
provide the downlink transmission using a unified TCI state of the multiple unified TCI states based on the downlink transmission being within the threshold amount of time following the control information.

14. The apparatus of claim 13, wherein the at least one processor is further configured to:
provide, before providing the control information scheduling the downlink transmission and via one of radio resource control (RRC) signaling, a medium access control (MAC) control element (CE) (MAC-CE), or downlink control information (DCI), an indication for the particular wireless device to use the unified TCI state as a default TCI state for downlink transmissions scheduled within the threshold amount of time.

15. The apparatus of claim 13, wherein the at least one processor is further configured to:
provide, before providing the control information, a first TCI indication indicating a first TCI codepoint associated with two unified TCI states, wherein the multiple unified TCI states comprise the two unified TCI states associated with the first TCI codepoint, wherein the control information includes a TCI selection indication to use at least one unified TCI state associated with the first TCI codepoint for receiving the downlink transmission, and wherein the control information is a single downlink control information (sDCI) associated with the multiple TRPs.

16. The apparatus of claim 15, wherein the unified TCI state is a first indicated unified TCI associated with the first TCI codepoint.

17. The apparatus of claim 15, wherein the unified TCI state is associated with a physical cell identifier (PCI) associated with a cell serving the particular wireless device.

18. The apparatus of claim 17, wherein the two unified TCI states associated with the first TCI codepoint comprise the unified TCI state associated with the PCI associated with the cell serving the particular wireless device and a second unified TCI state associated with a second PCI associated with a different cell.

19. The apparatus of claim 15, wherein the unified TCI state is associated with a control resource set (CORESET) associated with a lowest identifier among the two unified TCI states.

20. The apparatus of claim 19, wherein the at least one processor is further configured to:
provide, before providing the control information and after providing the first TCI indication, a second TCI indication indicating an additional unified TCI state associated with the CORESET associated with the lowest identifier.

21-48. (canceled)
